(19) United States
(12) Patent Application Publication
(10) Pub. No.: US 2014/0293509 A1
(43) Pub. Date: Oct. 2, 2014

(54) Electric Double Layer Capacitor Electrode and Electric Double Layer Capacitor

(71) Applicant: Funai Electric Co., Ltd., Osaka (JP)

(72) Inventors: Takeshi SHIMOMURA, Tsukuba-shi (JP); Touru SUMIYA, Tsukuba-shi (JP); Masao SUZUKI, Tsukuba-shi (JP); Shigeki KIHARA, Tsukuba-shi (JP); Masatoshi ONO, Tsukuba-shi (JP)

(73) Assignee: Funai Electric Co., Ltd., Osaka (JP)

(21) Appl. No.: 14/224,662

(22) Filed: Mar. 25, 2014

(30) Foreign Application Priority Data
Mar. 26, 2013 (JP) 2013-063165
Mar. 26, 2013 (JP) 2013-063169
Jan. 22, 2014 (JP) 2014-009329

(51) Int. Cl. H01G 11/30; H01G 11/26

(52) U.S. Cl. CPC H01G 11/30; H01G 11/26
USPC 361/502

(57) ABSTRACT

An electric double layer capacitor electrode includes a positive electrode having a positive electrode active material layer including a positive electrode side porous body and a negative electrode having a negative electrode active material layer including a negative electrode side porous body. An oxidation-reduction substance causing an oxidation-reduction reaction during charging and discharging is adsorbed onto at least one of the positive electrode side porous body of the positive electrode active material layer and the negative electrode side porous body of the negative electrode active material layer.

### BACKGROUND OF THE INVENTION

1. Field of the Invention

The present invention relates to an electric double layer capacitor electrode and an electric double layer capacitor including this electrode.

2. Description of the Background Art

In general, an electric double layer capacitor (also referred to as a “super capacitor”) is known as a power storage device excellent in power density, with short full charging/discharging time, and also excellent in cycle life. The electric double layer capacitor is mounted on various industrial devices, office automation equipment, home electric appliances, and industrial tools such as a smartphone, a forklift, and an idle stop vehicle. Such an electric double layer capacitor is disclosed in Japanese Patent Laying-Open No. 2007-305461, International Patent Application Publication WO2007/132786, and Japanese Patent Laying-Open No. 2012-114396, for example.

Japanese Patent Laying-Open No. 2007-305461 discloses a power storage device having a negative electrode including a negative electrode active material, an electrolyte, and a positive electrode. The positive electrode of this power storage device includes a current collector and a positive electrode active material formed on a surface of the current collector, containing a conductive material and an organic polymer compound. The organic polymer compound contained as the positive electrode active material has a reaction mechanism of multi-electron reaction involving at least two electrons.

International Patent Application Publication WO2007/132786 proposes a power storage device or the like including a positive electrode, a negative electrode, and an electrolyte. In the power storage device, at least one of the positive electrode and the negative electrode contains an organic compound having a portion contributing to an oxidation-reduction reaction as an active material. The organic compound contained as the active material is crystalline in both a charged state and a discharged state.

The positive electrode according to Japanese Patent Laying-Open No. 2007-305461 or at least one of the positive electrode and the negative electrode according to International Patent Application Publication WO2007/132786 contains the organic polymer compound or the organic compound in an unchanged condition as the active material.

Japanese Patent Laying-Open No. 2012-114396 proposes a super capacitor including an electrode having a multi layered structure including at least two active material layers, which are an activated carbon layer and a graphene layer, on an electrode current collector.

In the conventional electric double layer capacitor such as the power storage device described in each of Japanese Patent Laying-Open No. 2007-305461, International Patent Application Publication WO2007/132786, and Japanese Patent Laying-Open No. 2012-114396, however, energy density is disadvantageously small, as compared with a chemical cell such as a lithium-ion rechargeable battery or a nickel-hydride rechargeable battery. Thus, improvement in the energy density of the electric double layer capacitor is required in order to further expand an application.

### SUMMARY OF THE INVENTION

The present invention has been proposed in order to solve the aforementioned problem, and an object of the present invention is to provide an electric double layer capacitor having high energy density and an electric double layer capacitor electrode configured to attain the same.

An electric double layer capacitor electrode according to a first aspect of the present invention includes a positive electrode having a positive electrode active material layer including a positive electrode side porous body and a negative electrode having a negative electrode active material layer including a negative electrode side porous body, while an oxidation-reduction substance causing an oxidation-reduction reaction during charging and discharging is adsorbed onto at least one of the positive electrode side porous body of the positive electrode active material layer and the negative electrode side porous body of the negative electrode active material layer.

In the electric double layer capacitor electrode according to the first aspect of the present invention, the oxidation-reduction substance causing the oxidation-reduction reaction during charging and discharging is adsorbed onto at least one of the positive electrode side porous body of the positive electrode active material layer and the negative electrode side porous body of the negative electrode active material layer, whereby the area of the electric double layer is increased by the porous bodies so that the electric double layer capacity can be increased, and the pseudo-capacity caused by the oxidation-reduction reaction of the oxidation-reduction substance can be added to the electric double layer capacity, and hence an electric double layer capacitor having high energy density can be provided.

In the aforementioned electric double layer capacitor electrode according to the first aspect, the oxidation-reduction substance changing from a reduced state to an oxidized state due to an oxidation reaction during charging and changing from the oxidized state to the reduced state due to a reduction reaction during discharging is preferably adsorbed onto the positive electrode side porous body. According to this structure, in the positive electrode, electrons are emitted during charging and are received during discharging, and hence the oxidation-reduction substance adsorbed onto the positive electrode side porous body changes from the reduced state to the oxidized state due to the oxidation reaction during charging, whereby electrons are also emitted from the oxidation-reduction substance. Therefore, a larger number of electrons can be emitted from the positive electrode. Furthermore, the oxidation-reduction substance adsorbed onto the positive electrode side porous body changes from the oxidized state to the reduced state due to the reduction reaction during discharging, whereby electrons are also received by the oxidation-reduction substance. Therefore, a larger number of electrons can be received by the positive electrode. Consequently, the pseudo-capacity can be further increased in the positive electrode.

In the aforementioned electric double layer capacitor electrode according to the first aspect, the oxidation-reduction substance changing from an oxidized state to a reduced state due to a reduction reaction during charging and changing from the reduced state to the oxidized state due to an oxidation reaction during discharging is preferably adsorbed onto the negative electrode side porous body. According to this structure, in the negative electrode, electrons are received during charging and are emitted during discharging, and hence the oxidation-reduction substance adsorbed onto the negative electrode side porous body changes from the oxidized state to the reduced state due to the reduction reaction during charging, whereby electrons are also received by the oxidation-reduction substance. Therefore, a larger number of electrons can be received by the negative electrode. Furthermore, the oxidation-reduction substance adsorbed onto the negative electrode side porous body changes from the reduced state to the oxidized state due to the oxidation reaction during discharging, whereby electrons are also emitted from the oxidation-reduction substance. Therefore, a larger number of electrons can be emitted from the negative electrode. Consequently, the pseudo-capacity can be further increased in the negative electrode.

In the aforementioned electric double layer capacitor electrode according to the first aspect, the oxidation-reduction substance changing from a reduced state to an oxidized state due to an oxidation reaction during charging and changing from the oxidized state to the reduced state due to a reduction reaction during discharging is preferably adsorbed onto the positive electrode side porous body, and the oxidation-reduction substance changing from the oxidized state to the reduced state due to the reduction reaction during charging and changing from the reduced state to the oxidized state due to the oxidation reaction during discharging is preferably adsorbed onto the negative electrode side porous body. According to this structure, the pseudo-capacity can be further increased in both the positive electrode and the negative electrode, and hence an electric double layer capacitor having higher energy density can be provided.

In the aforementioned electric double layer capacitor electrode according to the first aspect, the oxidation-reduction substance is preferably adsorbed onto the negative electrode side porous body, and the oxidation-reduction substance having higher oxidation-reduction potential than the oxidation-reduction substance adsorbed onto the negative electrode side porous body is preferably adsorbed onto the positive electrode side porous body. According to this structure, the oxidation-reduction substance of the negative electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter charging is performed. Furthermore, the oxidation-reduction substance of the positive electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter discharging is performed. In addition, the oxidation-reduction substance of the positive electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter charging is performed. Moreover, the oxidation-reduction substance of the negative electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter discharging is performed. Consequently, the pseudo-capacity can be caused even in the case where both the oxidation-reduction substance of the negative electrode side porous body and the oxidation-reduction substance of the positive electrode side porous body are in the same oxidized/reduced state, and hence the electric double layer capacitor having high energy density can be provided.

In the aforementioned electric double layer capacitor electrode according to the first aspect, the oxidation-reduction substance adsorbed onto at least one of the positive electrode side porous body and the negative electrode side porous body preferably includes an oxidation-reduction substance capable of causing a multi-electron oxidation-reduction reaction involving the movement of a plurality of electrons. According to this structure, the number of electrons capable of being given and received in the oxidation-reduction substance can be increased, and hence the electric double layer capacitor having higher energy density can be provided.

In the aforementioned electric double layer capacitor electrode according to the first aspect, the oxidation-reduction substance adsorbed onto at least one of the positive electrode side porous body and the negative electrode side porous body preferably has a functional group in which a ketone group becomes a reduced hydroxyl group in a reduced state and a hydroxyl group becomes an oxidized ketone group in an oxidized state. According to this structure, the oxidation-reduction reaction is effectively caused in the electric double layer capacitor electrode when the electric double layer capacitor is charged and discharged, and hence the electric double layer capacitor having high energy density can be easily provided.

In this case, the oxidation-reduction substance adsorbed onto at least one of the positive electrode side porous body and the negative electrode side porous body preferably includes an oxidation-reduction substance selected from a hydroquinone derivative expressed by the following general formula (1), a catechol derivative expressed by the following general formula (2), a resorcinol derivative expressed by the following general formula (3), a benzoquinone derivative expressed by the following general formula (4), and a benzoquinone derivative expressed by the following general formula (5):

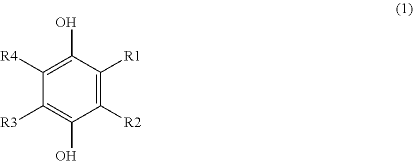

where R1, R2, R3, and R4 represent groups selected from a hydrogen atom, an alkyl group, an aryl group, an alkoxy group, a hydroxyl group, a nitro group, an alkyl carbonyl group, a formyl group, a sulfonic acid group (part or all may form a cation and a salt), a carboxyl group, and an alkoxycarbonyl group, or at least one of a set of R1 and R2 and a set of R3 and R4 may be fused to each other to form a five or six member fused ring,

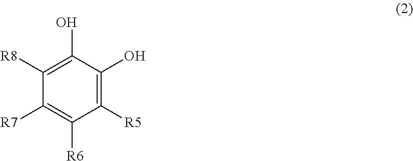

where R5, R6, R7, and R8 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R5 and R6, a set of R6 and R7, and a set of R7 and R8 may be fused to each other to form the five or six member fused ring,

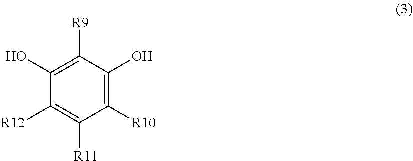

where R9, R10, R11, and R12 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or one of a set of R10 and R11 and a set of R11 and R12 may be fused to each other to form the five or six member fused ring,

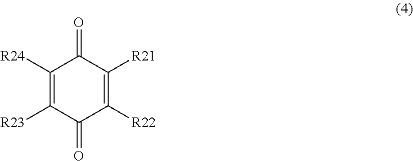

where R21, R22, R23, and R24 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R21 and R22 and a set of R23 and R24 may be fused to each other to form the five or six member fused ring, and

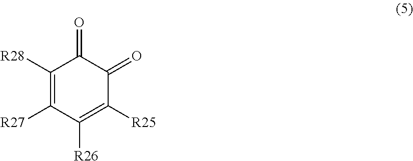

where R25, R26, R27, and R28 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R25 and R26, a set of R26 and R27, and a set of R27 and R28 may be fused to each other to form the five or six member fused ring.

According to this structure, as the oxidation-reduction substance, the oxidation-reduction substance selected from the hydroquinone derivative expressed by the aforementioned general formula (1), the catechol derivative expressed by the aforementioned general formula (2), the resorcinol derivative expressed by the aforementioned general formula (3), the benzoquinone derivative expressed by the aforementioned general formula (4), and the benzoquinone derivative expressed by the aforementioned general formula (5) is employed, whereby the oxidation-reduction reaction is more effectively caused in the electrical double layer capacitor electrode when the electric double layer capacitor is charged and discharged, and hence the energy density of the electric double layer capacitor can be easily increased.

In the aforementioned electric double layer capacitor electrode according to the first aspect, the oxidation-reduction substance adsorbed onto at least one of the positive electrode side porous body and the negative electrode side porous body preferably includes an oxidation-reduction substance selected from a quinone coenzyme and a vitamin coenzyme causing the oxidation-reduction reaction during charging and discharging. According to this structure, the oxidation-reduction reaction is effectively caused in the electric double layer capacitor electrode when the electric double layer capacitor is charged and discharged, and hence the energy density of the electric double layer capacitor can be easily increased.

In the aforementioned electric double layer capacitor electrode according to the first aspect, at least one of the positive electrode side porous body and the negative electrode side porous body is preferably made of conductive carbon material. According to this structure, a conductive auxiliary agent added to the porous body can be eliminated or reduced by employing the porous body made of the conductive carbon material. Thus, the manufacturing cost for the electric double layer capacitor electrode can be reduced, and the degree of freedom of selection of the type and quantity of the conductive auxiliary agent can be increased.

An electric double layer capacitor according to a second aspect of the present invention includes a positive electrode having a positive electrode active material layer including a positive electrode side porous body and a negative electrode having a negative electrode active material layer including a negative electrode side porous body, while an oxidation-reduction substance causing an oxidation-reduction reaction during charging and discharging is adsorbed onto at least one of the positive electrode side porous body of the positive electrode active material layer and the negative electrode side porous body of the negative electrode active material layer.

In the electric double layer capacitor according to the second aspect of the present invention, the oxidation-reduction substance causing the oxidation-reduction reaction during charging and discharging is adsorbed onto at least one of the positive electrode side porous body of the positive electrode active material layer and the negative electrode side porous body of the negative electrode active material layer, whereby the area of the electric double layer is increased by the porous bodies so that the electric double layer capacity can be increased, and the pseudo-capacity caused by the oxidation-reduction reaction of the oxidation-reduction substance can be added to the electric double layer capacity, and hence an electric double layer capacitor having high energy density can be provided.

In the aforementioned electric double layer capacitor according to the second aspect, the oxidation-reduction substance changing from a reduced state to an oxidized state due to an oxidation reaction during charging and changing from the oxidized state to the reduced state due to a reduction reaction during discharging is preferably adsorbed onto the positive electrode side porous body. According to this structure, in the positive electrode, electrons are emitted during charging and are received during discharging, and hence the oxidation-reduction substance adsorbed onto the positive electrode side porous body changes from the reduced state to the oxidized state due to the oxidation reaction during charging, whereby electrons are also emitted from the oxidation-reduction substance. Therefore, a larger number of electrons can be emitted from the positive electrode. Furthermore, the oxidation-reduction substance adsorbed onto the positive electrode side porous body changes from the oxidized state to the reduced state due to the reduction reaction during discharging, whereby electrons are also received by the oxidation-reduction substance. Therefore, a larger number of electrons can be received by the positive electrode. Consequently, the pseudo-capacity can be further increased in the positive electrode.

In the aforementioned electric double layer capacitor according to the second aspect, the oxidation-reduction substance changing from an oxidized state to a reduced state due to a reduction reaction during charging and changing from the reduced state to the oxidized state due to an oxidation reaction during discharging is preferably adsorbed onto the negative electrode side porous body. According to this structure, in the negative electrode, electrons are received during charging and are emitted during discharging, and hence the oxidation-reduction substance adsorbed onto the negative electrode side porous body changes from the oxidized state to the reduced state due to the reduction reaction during charging, whereby electrons are also received by the oxidation-reduction substance. Therefore, a larger number of electrons can be received by the negative electrode. Furthermore, the oxidation-reduction substance adsorbed onto the negative electrode side porous body changes from the reduced state to the oxidized state due to the oxidation reaction during discharging, whereby electrons are also emitted from the oxidation-reduction substance. Therefore, a larger number of electrons can be emitted from the negative electrode. Consequently, the pseudo-capacity can be further increased in the negative electrode.

In the aforementioned electric double layer capacitor according to the second aspect, the oxidation-reduction substance changing from a reduced state to an oxidized state due to an oxidation reaction during charging and changing from the oxidized state to the reduced state due to a reduction reaction during discharging is preferably adsorbed onto the positive electrode side porous body, and the oxidation-reduction substance changing from the oxidized state to the reduced state due to the reduction reaction during charging and changing from the reduced state to the oxidized state due to the oxidation reaction during discharging is preferably adsorbed onto the negative electrode side porous body. According to this structure, the pseudo-capacity can be further increased in both the positive electrode and the negative electrode, and hence an electric double layer capacitor having higher energy density can be provided.

In the aforementioned electric double layer capacitor according to the second aspect, the oxidation-reduction substance is preferably adsorbed onto the negative electrode side porous body, and the oxidation-reduction substance having higher oxidation-reduction potential than the oxidation-reduction substance adsorbed onto the negative electrode side porous body is preferably adsorbed onto the positive electrode side porous body. According to this structure, the oxidation-reduction substance of the negative electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter charging is performed. Furthermore, the oxidation-reduction substance of the positive electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter discharging is performed. In addition, the oxidation-reduction substance of the positive electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter charging is performed. Moreover, the oxidation-reduction substance of the negative electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter discharging is performed. Consequently, the pseudo-capacity can be caused even in the case where both the oxidation-reduction substance of the negative electrode side porous body and the oxidation-reduction substance of the positive electrode side porous body are in the same oxidized/reduced state, and hence the electric double layer capacitor having high energy density can be provided.

In the aforementioned electric double layer capacitor according to the second aspect, the oxidation-reduction substance adsorbed onto at least one of the positive electrode side porous body and the negative electrode side porous body preferably includes an oxidation-reduction substance capable of causing a multi-electron oxidation-reduction reaction involving the movement of a plurality of electrons. According to this structure, the number of electrons capable of being given and received in the oxidation-reduction substance can be increased, and hence the electric double layer capacitor having higher energy density can be provided.

In the aforementioned electric double layer capacitor according to the second aspect, the oxidation-reduction substance adsorbed onto at least one of the positive electrode side porous body and the negative electrode side porous body preferably has a functional group in which a ketone group becomes a reduced hydroxyl group in a reduced state and a hydroxyl group becomes an oxidized ketone group in an oxidized state. According to this structure, the oxidation-reduction reaction is effectively caused in the electric double layer capacitor when the electric double layer capacitor is charged and discharged, and hence the electric double layer capacitor having high energy density can be easily provided.

In this case, the oxidation-reduction substance adsorbed onto at least one of the positive electrode side porous body and the negative electrode side porous body preferably includes an oxidation-reduction substance selected from a hydroquinone derivative expressed by the following general formula (1), a catechol derivative expressed by the following general formula (2), a resorcinol derivative expressed by the following general formula (3), a benzoquinone derivative expressed by the following general formula (4), and a benzoquinone derivative expressed by the following general formula (5):

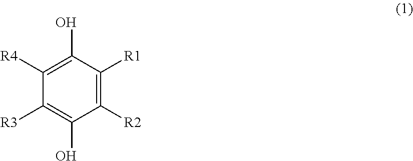

where R1, R2, R3, and R4 represent groups selected from a hydrogen atom, an alkyl group, an aryl group, an alkoxy group, a hydroxyl group, a nitro group, an alkyl carbonyl group, a formyl group, a sulfonic acid group (part or all may form a cation and a salt), a carboxyl group, and an alkoxycarbonyl group, or at least one of a set of R1 and R2 and a set of R3 and R4 may be fused to each other to form a five or six member fused ring,

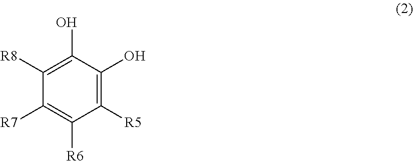

where R5, R6, R7, and R8 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R5 and R6, a set of R6 and R7, and a set of R7 and R8 may be fused to each other to form the five or six member fused ring,

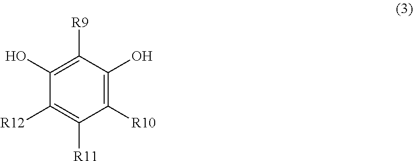

where R9, R10, R11, and R12 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or one of a set of R10 and R11 and a set of R11 and R12 may be fused to each other to form the five or six member fused ring,

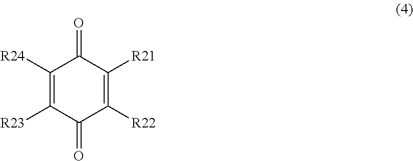

where R21, R22, R23, and R24 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R21 and R22 and a set of R23 and R24 may be fused to each other to form the five or six member fused ring, and

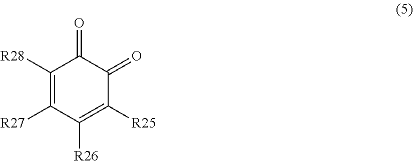

where R25, R26, R27, and R28 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R25 and R26, a set of R26 and R27, and a set of R27 and R28 may be fused to each other to form the five or six member fused ring.

According to this structure, as the oxidation-reduction substance, the oxidation-reduction substance selected from the hydroquinone derivative expressed by the aforementioned general formula (1), the catechol derivative expressed by the aforementioned general formula (2), the resorcinol derivative expressed by the aforementioned general formula (3), the benzoquinone derivative expressed by the aforementioned general formula (4), and the benzoquinone derivative expressed by the aforementioned general formula (5) is employed, whereby the oxidation-reduction reaction is more effectively caused in the electrical double layer capacitor when the electric double layer capacitor is charged and discharged, and hence the energy density of the electric double layer capacitor can be easily increased.

In the aforementioned electric double layer capacitor according to the second aspect, the oxidation-reduction substance adsorbed onto at least one of the positive electrode side porous body and the negative electrode side porous body preferably includes an oxidation-reduction substance selected from a quinone coenzyme and a vitamin coenzyme causing the oxidation-reduction reaction during charging and discharging. According to this structure, the oxidation-reduction reaction is effectively caused in one of the positive electrode and the negative electrode when the electric double layer capacitor is charged and discharged, and hence the energy density of the electric double layer capacitor can be easily increased.

An electric double layer capacitor electrode according to a third aspect of the present invention includes a positive electrode having a positive electrode active material layer including a positive electrode side porous body and a negative electrode having a negative electrode active material layer including a negative electrode side porous body, while at least one of a quinone coenzyme and a vitamin coenzyme causing an oxidation-reduction reaction during charging and discharging is adsorbed onto at least one of the positive electrode side porous body of the positive electrode active material layer and the negative electrode side porous body of the negative electrode active material layer.

In the electric double layer capacitor electrode according to the third aspect of the present invention, at least one of the quinone coenzyme and the vitamin coenzyme causing the oxidation-reduction reaction during charging and discharging is adsorbed onto at least one of the positive electrode side porous body of the positive electrode active material layer and the negative electrode side porous body of the negative electrode active material layer, whereby the area of the electric double layer is increased by the porous bodies so that the electric double layer capacity can be increased, and the pseudo-capacity caused by the oxidation-reduction reaction of the quinone coenzyme (vitamin coenzyme) can be added to the electric double layer capacity, and hence an electric double layer capacitor having high energy density can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing an electric double layer capacitor according to an embodiment of the present invention;

FIG. 2 is a sectional view showing the electric double layer capacitor according to the embodiment of the present invention;

FIG. 3 is a diagram for illustrating an oxidation-reduction reaction of HQ (in a reduced state) serving as an example of a quinone-based material, caused during charging and discharging;

FIG. 4 is a diagram for illustrating an oxidation-reduction reaction of nicotinamide adenine dinucleotide serving as an example of a coenzyme, caused during charging and discharging; and

FIG. 5 is a diagram showing charging and discharging curves of electric double layer capacitors according to an example, a reference example, and a comparative example.

### DESCRIPTION OF THE PREFERRED EMBODIMENTS

An embodiment of the present invention is hereinafter described with reference to the drawings.

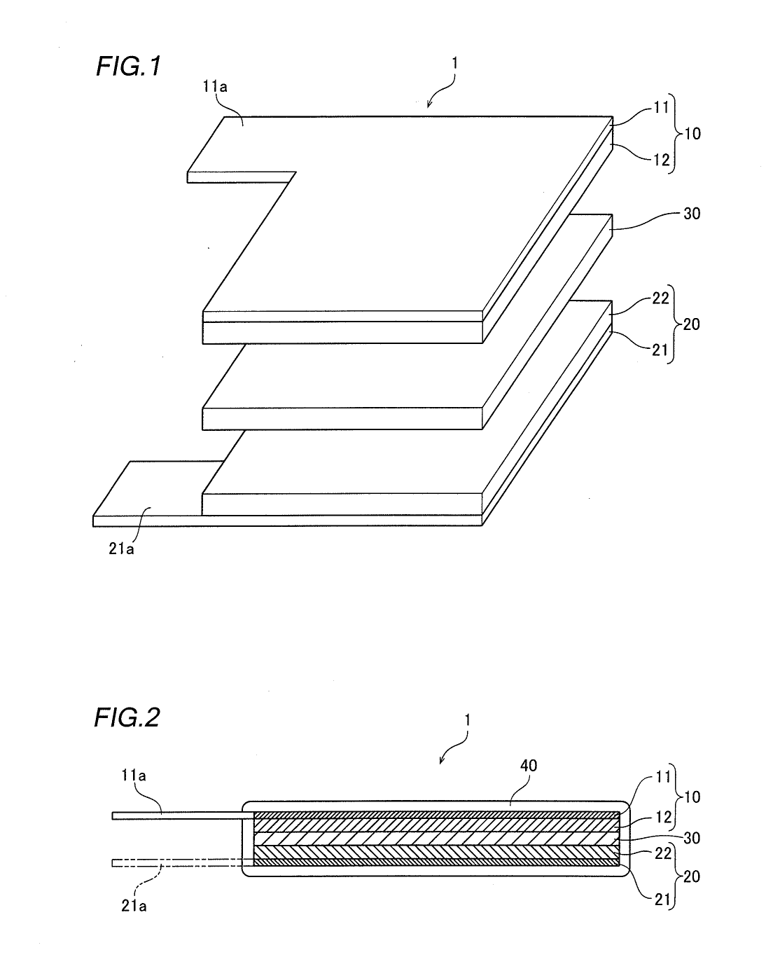

An electric double layer capacitor 1 according to the embodiment of the present invention is now described with reference to FIGS. 1 to 4.

The electric double layer capacitor 1 mainly includes a positive electrode current collector 11 and a negative electrode current collector 21 arranged to be opposed to each other, a positive electrode active material layer 12 formed on a first surface (a surface closer to the negative electrode current collector 21) of the positive electrode current collector 11, a negative electrode active material layer 22 formed on a first surface (a surface closer to the positive electrode current collector 11) of the negative electrode current collector 21, a separator 30 arranged between the positive electrode active material layer 12 and the negative electrode active material layer 22, and a housing 40 housing these, as shown in FIGS. 1 and 2. In FIG. 1, illustration of the housing 40 is omitted.

The current collectors 11 and 21 (the positive electrode current collector 11 and the negative electrode current collector 21) serve to electrically connect the active material layers 12 and 22 (the positive electrode active material layer 12 and the negative electrode active material layer 22) to an unshown external circuit(s), respectively. The current collectors 11 and 21 are formed with terminals 11a and 21a extracted to the outside of the housing 40, connected to the external circuit(s), respectively.

A material for the current collectors 11 and 21 is preferably a material having characteristics that (1) the material is excellent in electron conductivity, (2) the material stably exists in the capacitor, (3) the volume can be reduced in the capacitor (the thickness can be reduced), (4) the weight per unit volume is small (the weight can be reduced), (5) the material is easy to work with, (6) the material has practical strength, (7) the material has adhesiveness (mechanical adhesion), (8) the material is not corroded or dissolved by an electrolyte, etc. For example, a metal electrode material such as platinum, aluminum, gold, silver, copper, titanium, nickel, iron, or stainless steel may be employed, or a non-metal electrode material such as carbon, conductive rubber, or conductive polymer may be employed. Furthermore, at least the inner surface of the housing 40 can be formed of at least one of the metal electrode material and the non-metal electrode material, and the active material layers 12 and 22 can be provided on the inner surface. In this case, the housing 40 also serves as the current collectors 11 and 21.

A positive electrode 10 of the electric double layer capacitor 1 is constituted by the positive electrode current collector 11 and the positive electrode active material layer 12 provided on a surface of the positive electrode current collector 11. A negative electrode 20 of the electric double layer capacitor 1 is constituted by the negative electrode current collector 21 and the negative electrode active material layer 22 provided on a surface of the negative electrode current collector 21. The positive electrode 10 and the negative electrode 20 are examples of the “electric double layer capacitor electrode” in the present invention.

The active material layers 12 and 22 are provided on the surfaces of the current collectors 11 and 21, respectively and serve to form electric double layers on interfaces between the active material layers 12 and 22 and an electrolyte contained in the separator 30. The active material layers 12 and 22 each include porous bodies (a positive electrode side porous body and a negative electrode side porous body), a conductive auxiliary agent, and a binder resin.

The porous bodies included in the active material layers 12 and 22 serve to increase the electrostatic capacity of the electric double layer capacitor 1 by increasing a contact area with the electrolyte contained in the separator 30. The porous bodies may be conductive porous bodies such as active charcoal or insulating porous bodies such as silica, but the porous bodies are preferably conductive porous bodies in terms of use as an electrode material. Furthermore, the porous bodies are more preferably conductive porous bodies made of conductive carbon material in terms of manufacturing costs. The conductive carbon material is not particularly restricted but may be powdery, granular, fibrous, or shaped activated carbon, carbon black such as acetylene black, furnace black, channel black, thermal black, or Ketjen black (registered trademark), carbon fiber, carbon nanotube, fullerene, graphene, or the like, for example, and a carbon-based material whose specific surface area is at least 20 m²/g is preferable. These carbon-based materials may be employed separately or in mixture, and porosity may be improved or the specific surface area may be increased by forming holes in a surface or inner portion of the aforementioned conductive carbon material by a physical or chemical method. The type and quantity of the conductive auxiliary agent are selected properly, whereby the insulating porous bodies can be also employed suitably as the porous bodies included in the active material layers 12 and 22.

According to this embodiment, an oxidation-reduction substance causing an oxidation-reduction reaction when the electric double layer capacitor 1 is charged and discharged is adsorbed onto at least one of the positive electrode side porous body included in the positive electrode active material layer 12 and the negative electrode side porous body included in the negative electrode active material layer 22. The oxidation-reduction substance may be physically adsorbed onto the porous bodies with van der Waals' force or chemically adsorbed onto the porous bodies by covalent bonding such that a functional group of the oxidation-reduction substance is modified to the porous bodies and is coupled to each other. At this time, the oxidation-reduction substance may be adsorbed inside or outside pores of the porous bodies. The oxidation-reduction substance may be directly (physically or chemically) adsorbed onto (be coupled to) surfaces of the porous bodies or indirectly adsorbed onto the porous bodies by being stuck in the pores of the porous bodies. The size of the pores of the porous bodies is not particularly restricted, but the pores of the porous bodies are preferably nanosized.

The oxidation-reduction substance serves to spuriously increase the electrostatic capacity of the electric double layer capacitor 1 by giving and receiving electrons through the oxidation-reduction reaction. The oxidation-reduction substance adsorbed onto the porous bodies is arbitrarily selectable but is preferably an oxidation-reduction substance causing a multi-electron oxidation-reduction reaction involving the movement of a plurality of electrons in terms of an increase in capacity.

As the oxidation-reduction substance causing the multi-electron oxidation-reduction reaction, a quinone-based material having a functional group in which a ketone group becomes a reduced hydroxyl group in a reduced state and a hydroxyl group becomes an oxidized ketone group in an oxidized state, causing a two-electron oxidation-reduction reaction involving the movement of two electrons can be employed, for example.

As the quinone-based material, a hydroquinone derivative expressed by the aforementioned general formula (1), a catechol derivative expressed by the aforementioned general formula (2), a resorcinol derivative expressed by the aforementioned general formula (3), benzoquinone derivatives expressed by the aforementioned general formulae (4) and (5), or the like can be employed, for example.

In the following formula (6), an example of the hydroquinone derivative (1,4-hydroquinone (HQ)) expressed by the aforementioned general formula (1) is shown, but this is illustrative. Thus, the hydroquinone derivative expressed by the aforementioned general formula (1) is not restricted to this.

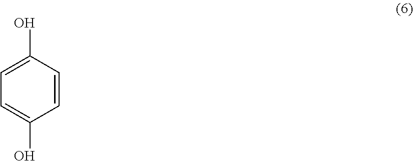

In the following formulae (7) to (10), examples of the benzoquinone derivative expressed by the aforementioned general formula (4) are shown, but these are illustrative. Thus, the benzoquinone derivative expressed by the aforementioned general formula (4) is not restricted to these. The formula (7) is 1,4-benzoquinone, and the formula (8) is 2,5-dihydroxy-1,4-benzoquinone (BQ). The formula (9) is 2,5-dimethoxy-1,4-benzoquinone (DEBQ), and the formula (10) is anthracene-9,10-dione (anthraquinone).

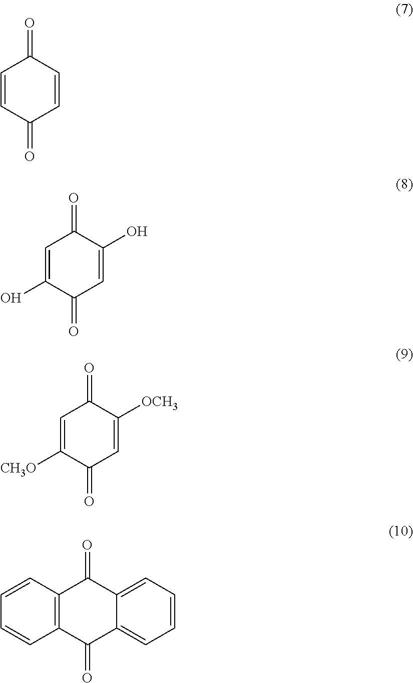

In the following formula (11), an example of the benzoquinone derivative (1,2-napthoquinone-4-sulfonic acid sodium salt (NQ)) expressed by the aforementioned general formula (5) is shown, but this is illustrative. Thus, the benzoquinone derivative expressed by the aforementioned general formula (5) is not restricted to this.

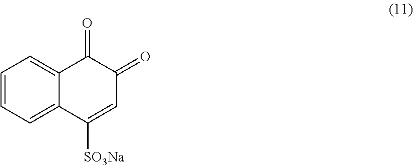

The hydroquinone derivative expressed by the aforementioned general formula (1) also includes a ring-expanded hydroquinone derivative obtained by ring-expanding the hydroquinone derivative expressed by the aforementioned general formula (1). Similarly, the catechol derivative expressed by the aforementioned general formula (2) also includes a ring-expanded catechol derivative obtained by ring-expanding the catechol derivative expressed by the aforementioned general formula (2). Similarly, the resorcinol derivative expressed by the aforementioned general formula (3) also includes a ring-expanded resorcinol derivative obtained by ring-expanding the resorcinol derivative expressed by the aforementioned general formula (3).

Furthermore, the benzoquinone derivative expressed by the aforementioned general formula (4) also includes a ring-expanded benzoquinone derivative obtained by ring-expanding the benzoquinone derivative expressed by the aforementioned general formula (4). In the following formula (12), an example of this ring-expanded benzoquinone derivative (5,7,12,14-pentacenetetrone (PCT)) is shown, but this is illustrative. Thus, the ring-expanded benzoquinone derivative included in the benzoquinone derivative expressed by the aforementioned general formula (4) is not restricted to this. Similarly, the benzoquinone derivative expressed by the aforementioned general formula (5) also includes a ring-expanded benzoquinone derivative obtained by ring-expanding the benzoquinone derivative expressed by the aforementioned general formula (5).

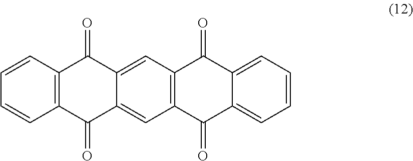

The oxidation-reduction substance includes an oxidation-reduction substance in a reduced state emitting electrons and an oxidation-reduction substance in an oxidized state receiving electrons.

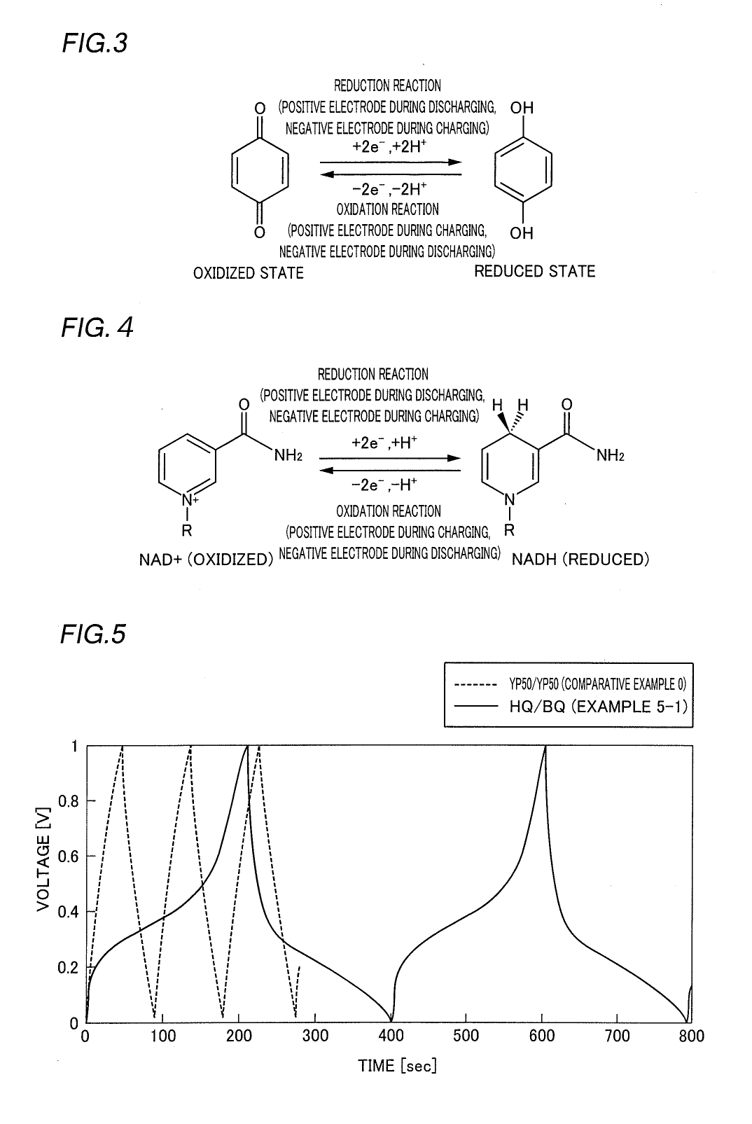

Specifically, the hydroquinone derivative expressed by the aforementioned general formula (1) is an oxidation-reduction substance in a reduced state. The hydroxyl group of this derivative is changed to a ketone group by a reaction (oxidation reaction) of emitting electrons, and this derivative turns to an oxidized state, as shown in FIG. 3, for example. The same holds for the catechol derivative expressed by the aforementioned general formula (2) and the resorcinol derivative expressed by the aforementioned general formula (3).

The benzoquinone derivative expressed by the aforementioned general formula (4) is an oxidation-reduction substance in an oxidized state. The ketone group of this derivative is changed to a hydroxyl group by a reaction (reduction reaction) of receiving electrons, and this derivative turns to a reduced state, as shown in FIG. 3, for example. The same holds for benzoquinone derivative expressed by the aforementioned general formula (5).

In order to increase the electrostatic capacity of the electric double layer capacitor 1 by giving and receiving electrons through the oxidation-reduction reaction, the oxidation-reduction substance adsorbed and immobilized on the porous bodies included in the active material layers 12 and 22 must cause the oxidation-reduction reaction when the electric double layer capacitor 1 is charged and discharged.

According to this embodiment, in the case where the oxidation-reduction substance is adsorbed onto the positive electrode side porous body included in the positive electrode active material layer 12, the oxidation-reduction substance changing from the reduced state to the oxidized state due to the oxidation reaction during charging and changing from the oxidized state to the reduced state due to the reduction reaction during discharging is adsorbed onto the positive electrode side porous body. In the case where the oxidation-reduction substance is adsorbed onto the negative electrode side porous body included in the negative electrode active material layer 22, the oxidation-reduction substance changing from the oxidized state to the reduced state due to the reduction reaction during charging and changing from the reduced state to the oxidized state due to the oxidation reaction during discharging is adsorbed onto the negative electrode side porous body.

The positive electrode 10 is an electrode into which electrons flow when the electric double layer capacitor 1 is charged and of which electrons flow out when the electric double layer capacitor 1 is discharged. Therefore, if the oxidation-reduction substance in the oxidized state receiving electrons is adsorbed onto the positive electrode side porous body included in the positive electrode active material layer 12 in the case where the electric double layer capacitor 1 is discharged for the first time from a charged state (constant current discharge), and the oxidation-reduction substance in the reduced state emitting electrons is adsorbed onto the positive electrode side porous body included in the positive electrode active material layer 12 in the case where the capacitor is charged for the first time from a discharged state (constant current charge), the oxidation-reduction substance adsorbed onto the positive electrode side porous body included in the positive electrode active material layer 12 can cause the oxidation-reduction reaction when the electric double layer capacitor 1 is charged and discharged and develop the pseudo-capacity.

The negative electrode 20 is an electrode of which electrons flow out when the electric double layer capacitor 1 is charged and into which electrons flow when the electric double layer capacitor 1 is discharged. Therefore, if the oxidation-reduction substance in the reduced state emitting electrons is adsorbed onto the negative electrode side porous body included in the negative electrode active material layer 22 in the case where the capacitor is discharged for the first time from the charged state (constant current discharge), and the oxidation-reduction substance in the oxidized state receiving electrons is adsorbed onto the negative electrode side porous body included in the negative electrode active material layer 22 in the case where the capacitor is charged for the first time from the discharged state (constant current charge), the oxidation-reduction substance adsorbed onto the negative electrode side porous body included in the negative electrode active material layer 22 can cause the oxidation-reduction reaction when the electric double layer capacitor 1 is charged and discharged and develop the pseudo-capacity.

Thus, the active material layers 12 and 22 including the porous bodies are provided on the surfaces of the current collectors 11 and 21, respectively, whereby the area of the electric double layers is increased as compared with the case where the porous bodies are not included in the active material layers, and hence the electric double layer capacity is increased. Consequently, the capacity of the electric double layer capacitor 1 can be increased. Furthermore, the oxidation-reduction substance causing the oxidation-reduction reaction during charging and discharging is adsorbed onto at least one of the positive electrode side porous body included in the positive electrode active material layer and the negative electrode side porous body included in the negative electrode active material layer, whereby the pseudo-capacity caused by the oxidation-reduction reaction of the oxidation-reduction substance can be added to the electric double layer capacity, and hence the capacity of the electric double layer capacitor 1 can be further increased.

The electrostatic energy U of the electric double layer capacitor 1 is expressed by U=(½)CV², is proportionate to an electrostatic capacity C, and is proportionate to the square of a voltage V. In other words, if the electrostatic capacity of the electric double layer capacitor 1 is increased, the energy density of the electric double layer capacitor 1 is also increased. Therefore, the electric double layer capacity is increased by the porous bodies, and the pseudo-capacity caused by the oxidation-reduction reaction of the oxidation-reduction substance is added to the electric double layer capacity, whereby the energy density of the electric double layer capacitor 1 can be increased.

The oxidation-reduction substance adsorbed onto the porous bodies is not restricted to the quinone-based material, but the oxidation-reduction substance can be arbitrarily changed so far as the same causes the oxidation-reduction reaction during charging and discharging.

The oxidation-reduction substance in the reduced state causing the oxidation-reduction reaction during charging and discharging may be an oxidation-reduction substance having a hydroxyl group (preferably an oxidation-reduction substance having a plurality of hydroxyl groups) other than the hydroquinone derivative expressed by the aforementioned general formula (1), the catechol derivative expressed by the aforementioned general formula (2), or the resorcinol derivative expressed by the aforementioned general formula (3), for example.

When the oxidation-reduction substance turns to an oxidized state due to the oxidation reaction, the hydroxyl group is oxidized to become a ketone group. When the oxidation-reduction substance turns to a reduced state due to the reduction reaction, the ketone group is reduced to be restored to the hydroxyl group. In other words, the oxidation-reduction substance having the hydroxyl group such as the hydroquinone derivative expressed by the aforementioned general formula (1), the catechol derivative expressed by the aforementioned general formula (2), or the resorcinol derivative expressed by the aforementioned general formula (3) has a functional group in which the ketone group becomes the reduced hydroxyl group in the reduced state and the hydroxyl group becomes the oxidized ketone group in the oxidized state.

The oxidation-reduction substance in the oxidized state causing the oxidation-reduction reaction during charging and discharging may be an oxidation-reduction substance having a ketone group (preferably an oxidation-reduction substance having a plurality of ketone groups) other than the benzoquinone derivative expressed by the aforementioned general formula (4) or (5), for example. There is Ingigo, Ingigo carmine, or the like as the oxidation-reduction substance having the ketone group other than the benzoquinone derivative expressed by the aforementioned general formula (4) or (5), for example.

This ketone group is reduced to become a hydroxyl group when the oxidation-reduction substance turns to a reduced state due to the reduction reaction, and the hydroxyl group is oxidized to be restored to the ketone group when the oxidation-reduction substance turns to an oxidized state due to the oxidation reaction. In other words, the oxidation-reduction substance having the ketone group such as the benzoquinone derivative expressed by the aforementioned general formula (4) or (5) has a functional group in which the ketone group becomes the reduced hydroxyl group in the reduced state and the hydroxyl group becomes the oxidized ketone group in the oxidized state.

Furthermore, as the oxidation-reduction substance causing the multi-electron oxidation-reduction reaction, a coenzyme such as a quinone coenzyme or a vitamin coenzyme can be also employed.

As the quinone coenzyme, pyrrolo-quinoline quinone, topa quinone, tryptophan tryptophylquinone, lysine tyrosylquinone, cysteinyl tryptophanquinone, or the like can be employed, for example.

As the vitamin coenzyme, nicotinamide adenine dinucleotide, flavin adenine dinucleotide, thiamine diphosphoric acid, pantothenic acid, or the like can be employed, for example.

In addition, as the oxidation-reduction substance causing the multi-electron oxidation-reduction reaction, an electron transmitting material such as ubiquinone, cytochrome, nicotinamide adenine dinucleotide phosphate, plastoquinone, plastocyanin, ferredoxin, chlorophyll, pheophytin, or thioredoxin can be also employed.

The coenzyme such as the quinone coenzyme or the vitamin coenzyme can be in two states that are a reduced state of emitting electrons and an oxidized state of receiving electrons. Specifically, reduced nicotinamide adenine dinucleotide (NADH) becomes oxidized nicotinamide adenine dinucleotide (NAD⁺) through the reaction (oxidation reaction) of emitting electrons, and the oxidized nicotinamide adenine dinucleotide (NAD⁺) becomes the reduced nicotinamide adenine dinucleotide (NADH) through the reaction (reduction reaction) of receiving electrons, as shown in FIG. 4, for example.

If the oxidized coenzyme (in the oxidized state) is adsorbed onto the positive electrode side porous body included in the positive electrode active material layer 12 in the case where the capacitor is discharged for the first time from the charged state (constant current discharge), and the reduced coenzyme (in the reduced state) is adsorbed onto the positive electrode side porous body included in the positive electrode active material layer 12 in the case where the capacitor is charged for the first time from the discharged state (constant current charge) when the coenzyme (the quinone coenzyme, the vitamin coenzyme, or the like) is adsorbed as the oxidation-reduction substance onto the positive electrode side porous body included in the positive electrode active material layer 12, the coenzyme adsorbed onto the positive electrode side porous body included in the positive electrode active material layer 12 can cause the oxidation-reduction reaction during charging and discharging of the electric double layer capacitor 1 and develop the pseudo-capacity.

If the reduced coenzyme (in the reduced state) is adsorbed onto the negative electrode side porous body included in the negative electrode active material layer 22 in the case where the capacitor is discharged for the first time from the charged state (constant current discharge), and the oxidized coenzyme (in the oxidized state) is adsorbed onto the negative electrode side porous body included in the negative electrode active material layer 22 in the case where the capacitor is charged for the first time from the discharged state (constant current charge) when the coenzyme (the quinone coenzyme, the vitamin coenzyme, or the like) is adsorbed as the oxidation-reduction substance onto the negative electrode side porous body included in the negative electrode active material layer 22, the coenzyme adsorbed onto the negative electrode side porous body included in the negative electrode active material layer 22 can cause the oxidation-reduction reaction during charging and discharging of the electric double layer capacitor 1 and develop the pseudo-capacity.

In the case where the oxidation-reduction substance is adsorbed onto the positive electrode side porous body included in the positive electrode active material layer 12, one or a plurality of substances may be adsorbed as the oxidation-reduction substance causing the oxidation-reduction reaction during charging and discharging, that is an oxidation-reduction substance changing from the reduced state to the oxidized state during charging and changing from the oxidized state to the reduced state during discharging, onto the positive electrode side porous body. At this time, both the quinone coenzyme and the vitamin coenzyme may be adsorbed onto the positive electrode side porous body.

Similarly, in the case where the oxidation-reduction substance is adsorbed onto the negative electrode side porous body included in the negative electrode active material layer 22, one or a plurality of substances may be adsorbed as the oxidation-reduction substance causing the oxidation-reduction reaction during charging and discharging, that is an oxidation-reduction substance changing from the oxidized state to the reduced state during charging and changing from the reduced state to the oxidized state during discharging, onto the negative electrode side porous body. At this time, both the quinone coenzyme and the vitamin coenzyme may be adsorbed onto the negative electrode side porous body.

In the positive electrode active material layer 12, one or a plurality of porous bodies may be included as the positive electrode side porous body. Similarly, in the negative electrode active material layer 22, one or a plurality of porous bodies may be included as the negative electrode side porous body. Furthermore, the positive electrode side porous body included in the positive electrode active material layer 12 and the negative electrode side porous body included in the negative electrode active material layer 22 may be identical to each other or different from each other.

When the oxidation-reduction substance is adsorbed onto both the positive electrode side porous body included in the positive electrode active material layer 12 and the negative electrode side porous body included in the negative electrode active material layer 22, the oxidation-reduction substance in the oxidized state is preferably adsorbed onto the positive electrode side porous body included in the positive electrode active material layer 12 and the oxidation-reduction substance in the reduced state is preferably adsorbed onto the negative electrode side porous body included in the negative electrode active material layer 22 in the case where the capacitor is discharged for the first time from the charged state (constant current discharge: during discharging), and the oxidation-reduction substance in the reduced state is preferably adsorbed onto the positive electrode side porous body included in the positive electrode active material layer 12 and the oxidation-reduction substance in the oxidized state is preferably adsorbed onto the negative electrode side porous body included in the negative electrode active material layer 22 in the case where the capacitor is charged for the first time from the discharged state (constant current charge: during charging).

Alternatively, the oxidation-reduction substance in the same state (the oxidized state or the reduced state) may be adsorbed onto both the positive electrode side porous body included in the positive electrode active material layer 12 and the negative electrode side porous body included in the negative electrode active material layer 22. In this case, whether the oxidation-reduction substance adsorbed onto the positive electrode 10 and the oxidation-reduction substance adsorbed onto the negative electrode 20 exist in the oxidized state or the reduced state at certain potential depends on a relative combination of these adsorbed oxidation-reduction substances.

In other words, if the oxidation-reduction substance having higher oxidation-reduction potential is adsorbed onto the positive electrode side porous body included in the positive electrode active material layer 12 and the oxidation-reduction substance having lower oxidation-reduction potential is adsorbed onto the negative electrode side porous body included in the negative electrode active material layer 22 in both cases where the capacitor starts to be discharged from the charged state and where the capacitor starts to be charged from the discharged state when the oxidation-reduction substance in the same state (the oxidized state or the reduced state) is adsorbed onto both the positive electrode side porous body included in the positive electrode active material layer 12 and the negative electrode side porous body included in the negative electrode active material layer 22, this oxidation-reduction substance can cause the oxidation-reduction reaction during charging and discharging of the electric double layer capacitor 1 and develop the pseudo-capacity. Thus, this oxidation-reduction substance is preferable.

Furthermore, the oxidation-reduction substance adsorbed onto the porous bodies is preferably a substance capable of reversibly changing in the oxidized state and the reduced state.

The conductive auxiliary agent included in the active material layers 12 and 22 serves to reduce the internal resistance of the electric double layer capacitor 1. As the conductive auxiliary agent, carbon black such as acetylene black, furnace black, channel black, thermal black, or Ketjen black (registered trademark) can be employed, for example.

The binder resin included in the active material layers 12 and 22 serves to fix the porous bodies and the conductive auxiliary agent to each other in mixture. As the binder resin, styrene-butadiene rubber (SBR), polytetrafluoroethylene (PTFE), polyvinylidene fluoride (PVdF), tetrafluoroethylene-propylene (FEPM), elastomer binder, or the like can be employed, for example. The porous bodies, the conductive auxiliary agent, and the binder resin are kneaded by a wet method or a dry method, whereby the active material layers 12 and 22 can be formed, and the current collectors 11 and 21 can be coated with the formed active material layers 12 and 22, respectively.

The separator 30 is arranged between the positive electrode 10 and the negative electrode 20 adjacent to each other and serves to prevent short resulting from contact of the positive electrode 10 with the negative electrode 20 in the housing 40. As a material for the separator 30, an insulating material capable of holding the electrolyte can be employed and is preferably arbitrarily employed depending on whether the electrolyte contained in the separator 30 is aqueous or non-aqueous. Specifically, as the separator 30, a film of polyolefin, polytetrafluoroethylene (PTFE), polyethylene, cellulose, polyvinylidene fluoride (PVdF), or the like can be employed, for example.

The electrolyte contained in the separator 30 serves to form the electric double layers on the interfaces between the positive electrode current collector 11 and the negative electrode current collector 21 and the electrolyte by penetrating into the positive electrode active material layer 12 and the negative electrode active material layer 22. The electrolyte contained in the separator 30 may be aqueous or non-aqueous.

As the electrolyte, an aqueous solution of a prescribed supporting electrolyte (aqueous electrolyte) or a prescribed supporting electrolyte dissolved in a prescribed organic solvent (non-aqueous electrolyte) can be employed. As the prescribed supporting electrolyte, a compound expressed by the following general formula (13), a compound expressed by the following general formula (14), or the like can be employed, for example.

M₁X₁ (13)

In the formula, M₁ represents H, Li, Na, K, Rb, Cs, H₂, or NH₄. In the formula, X₁ represents SO₄, Cl, OH, ClO₄, BF₄, CF₃SO₃, or PF₆.

(Rₐ)ₙ(R_{b})ₘNX₂ (14)

In the formula, Rₐ represents an alkyl group or an aryl group. In the formula, R_{b} represents an alkyl group. N in the formula represents a nitrogen atom. In the formula, X₂ represents Cl, Br, I, ClO₄, BF₄, CF₃SO₃, or PF₆. In the formula, n represents 0, 1, or 2, and in the formula, m represents 4−n.

The typical supporting electrolyte of the aqueous electrolyte is H₂SO₄, HCl, KCl, NaCl, KOH, OH, or the like, and the typical supporting electrolyte of the non-aqueous electrolyte is tetraethylammonium tetrafluoroborate (TEABF₄), tetraethylammonium hexafluorophosphate (TEAPF₆), lithium tetrafluoroborate (LiBF₄), lithium hexafluorophosphate (LiPF₆), or lithium perchlorate (LiClO₄). However, the supporting electrolytes are not restricted to these.

As the prescribed organic solvent, a cyclic carbonate such as an ethylene carbonate (EC) or a propylene carbonate (PC), a linear carbonate such as an ethyl methyl carbonate (EMC), a diethyl carbonate (DEC), or a dimethyl carbonate (DMC), γ-butyrolactone (GBL), acetonitrile (AN), sulfolane (SL), a mixture of these at an arbitrary ratio, or the like can be employed, for example.

The electrolyte may include one or a plurality of supporting electrolytes.

The housing 40 serves to house a laminated body of the current collectors 11 and 21, the active material layers 12 and 22, and the separator 30 containing the electrolyte. The housing 40 is insulated from the current collectors 11 and 21. As a material for the housing 40, a laminated film material of aluminum, stainless steel, titanium, nickel, platinum, gold, or the like or a laminated film material of alloy of these can be employed.

A method for manufacturing the electric double layer capacitor 1 according to this embodiment is now described.

First, an active material (the positive electrode side porous body, the conductive auxiliary agent, and the binder resin for the positive electrode active material layer 12) for forming the positive electrode active material layer 12 and a binder are kneaded with each other, and a positive electrode active material slurry is prepared.

Furthermore, an active material (the negative electrode side porous body, the conductive auxiliary agent, and the binder resin for the negative electrode active material layer 22) for forming the negative electrode active material layer 22 and a binder are kneaded with each other, and a negative electrode active material slurry is prepared.

At this time, the oxidation-reduction substance causing the oxidation-reduction reaction when the electric double layer capacitor 1 is charged and discharged is adsorbed onto at least one of the positive electrode side porous body for the positive electrode active material layer 12 and the negative electrode side porous body for the negative electrode active material layer 22.

As the binder, a carboxymethylcellulose (CMC) aqueous solution or the like can be employed, for example.

Then, the positive electrode 10 is prepared. Specifically, the positive electrode active material slurry is applied onto the positive electrode current collector 11 and is dried, whereby the positive electrode active material layer 12 is formed on the surface of the positive electrode current collector 11. Furthermore, the negative electrode 20 is prepared. Specifically, the negative electrode active material slurry is applied onto the negative electrode current collector 21 and is dried, whereby the negative electrode active material layer 22 is formed on the surface of the negative electrode current collector 21.

Then, the positive electrode 10 and the negative electrode 20 are arranged such that the positive electrode active material layer 12 and the negative electrode active material layer 22 are opposed to each other, and the separator 30 containing the electrolyte is held therebetween, whereby a capacitor body is prepared.

Then, the capacitor body is housed in the housing 40, and the housing 40 is sealed by a reduction in pressure. Thus, the electric double layer capacitor 1 is completed.

According to this embodiment, the following advantageous effects can be obtained.

According to this embodiment, as hereinabove described, the oxidation-reduction substance is adsorbed onto at least one of the positive electrode side porous body included in the positive electrode active material layer 12 and the negative electrode side porous body included in the negative electrode active material layer 22. Thus, the electric double layer capacity can be increased by the porous bodies, and the pseudo-capacity caused by the oxidation-reduction reaction of the oxidation-reduction substance can be added to the electric double layer capacity, and hence the electric double layer capacitor 1 having high energy density can be provided.

According to this embodiment, the oxidation-reduction substance changing from the reduced state to the oxidized state due to the oxidation reaction during charging and changing from the oxidized state to the reduced state due to the reduction reaction during discharging is adsorbed onto the positive electrode side porous body in the case where the oxidation-reduction substance is adsorbed onto the positive electrode side porous body included in the positive electrode active material layer 12. Thus, in the positive electrode 10, electrons are emitted during charging and are received during discharging, and hence the oxidation-reduction substance adsorbed onto the positive electrode side porous body changes from the reduced state to the oxidized state due to the oxidation reaction during charging, whereby electrons are emitted from not only the positive electrode side porous body but also the oxidation-reduction substance. Therefore, a larger number of electrons can be emitted from the positive electrode 10. Furthermore, the oxidation-reduction substance adsorbed onto the positive electrode side porous body changes from the oxidized state to the reduced state due to the reduction reaction during discharging, whereby electrons are received by not only the positive electrode side porous body but also the oxidation-reduction substance. Therefore, a larger number of electrons can be received by the positive electrode 10. Consequently, the pseudo-capacity can be further increased in the positive electrode 10.

According to this embodiment, the oxidation-reduction substance changing from the oxidized state to the reduced state due to the reduction reaction during charging and changing from the reduced state to the oxidized state due to the oxidation reaction during discharging is adsorbed onto the negative electrode side porous body in the case where the oxidation-reduction substance is adsorbed onto the negative electrode side porous body included in the negative electrode active material layer 22. Thus, in the negative electrode 20, electrons are received during charging and are emitted during discharging, and hence the oxidation-reduction substance adsorbed onto the negative electrode side porous body changes from the oxidized state to the reduced state due to the reduction reaction during charging, whereby electrons are received by not only the negative electrode side porous body but also the oxidation-reduction substance. Therefore, a larger number of electrons can be received by the negative electrode 20. Furthermore, the oxidation-reduction substance adsorbed onto the negative electrode side porous body changes from the reduced state to the oxidized state due to the oxidation reaction during discharging, whereby electrons are emitted from not only the negative electrode side porous body but also the oxidation-reduction substance. Therefore, a larger number of electrons can be emitted from the negative electrode 20. Consequently, the pseudo-capacity can be further increased in the negative electrode 20.

According to this embodiment, the oxidation-reduction substance changing from the reduced state to the oxidized state due to the oxidation reaction during charging and changing from the oxidized state to the reduced state due to the reduction reaction during discharging is adsorbed onto the positive electrode side porous body, and the oxidation-reduction substance changing from the oxidized state to the reduced state due to the reduction reaction during charging and changing from the reduced state to the oxidized state due to the oxidation reaction during discharging is adsorbed onto the negative electrode side porous body. Thus, the pseudo-capacity can be further increased in both the positive electrode 10 and the negative electrode 20, and hence the electric double layer capacitor 1 having higher energy density can be provided.

According to this embodiment, the oxidation-reduction substance is adsorbed onto the negative electrode side porous body, and the oxidation-reduction substance having the higher oxidation-reduction potential than the oxidation-reduction substance adsorbed onto the negative electrode side porous body is adsorbed onto the positive electrode side porous body. According to this structure, the oxidation-reduction substance of the negative electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter charging is performed. Furthermore, the oxidation-reduction substance of the positive electrode side porous body can be changed from the oxidized state to the reduced state in the case where both the oxidation-reduction substance adsorbed onto the negative electrode side porous body and the oxidation-reduction substance adsorbed onto the positive electrode side porous body are in the oxidized state, and thereafter discharging is performed. In addition, the oxidation-reduction substance of the positive electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter charging is performed. Moreover, the oxidation-reduction substance of the negative electrode side porous body can be changed from the reduced state to the oxidized state in the case where both the oxidation-reduction substance adsorbed onto the negative electrode side porous body and the oxidation-reduction substance adsorbed onto the positive electrode side porous body are in the reduced state, and thereafter discharging is performed. Consequently, the electric double layer capacitor 1 having high energy density can be provided even in the case where both the oxidation-reduction substance of the negative electrode side porous body and the oxidation-reduction substance of the positive electrode side porous body are in the same oxidized/reduced state.

According to this embodiment, the oxidation-reduction substance adsorbed onto at least one of the positive electrode side porous body and the negative electrode side porous body includes the oxidation-reduction substance capable of causing the multi-electron oxidation-reduction reaction involving the movement of a plurality of electrons. According to this structure, the number of electrons capable of being given and received in the oxidation-reduction substance can be increased, and hence the electric double layer capacitor 1 having higher energy density can be provided.

According to this embodiment, the oxidation-reduction substance adsorbed onto at least one of the positive electrode side porous body and the negative electrode side porous body has the functional group in which the ketone group becomes the reduced hydroxyl group in the reduced state and the hydroxyl group becomes the oxidized ketone group in the oxidized state. According to this structure, the oxidation-reduction reaction is effectively caused in at least one of the positive electrode 10 and the negative electrode 20 when the electric double layer capacitor 1 is charged and discharged, and hence the electric double layer capacitor 1 having high energy density can be easily provided.

According to this embodiment, as the oxidation-reduction substance adsorbed onto at least one of the positive electrode side porous body and the negative electrode side porous body, the oxidation-reduction substance selected from the hydroquinone derivative expressed by the aforementioned general formula (1), the catechol derivative expressed by the aforementioned general formula (2), the resorcinol derivative expressed by the aforementioned general formula (3), the benzoquinone derivative expressed by the aforementioned general formula (4), and the benzoquinone derivative expressed by the aforementioned general formula (5) is employed. Thus, the oxidation-reduction reaction is effectively caused when the electric double layer capacitor 1 is charged and discharged, and hence the energy density of the electric double layer capacitor 1 can be easily increased.

According to this embodiment, the oxidation-reduction substance adsorbed onto at least one of the positive electrode side porous body and the negative electrode side porous body includes the oxidation-reduction substance selected from the quinone coenzyme and the vitamin coenzyme causing the oxidation-reduction reaction during charging and discharging. Thus, the oxidation-reduction reaction is effectively caused in at least one of the positive electrode 10 and the negative electrode 20 when the electric double layer capacitor 1 is charged and discharged, and hence the energy density of the electric double layer capacitor 1 can be easily increased.

According to this embodiment, at least one of the positive electrode side porous body and the negative electrode side porous body includes the porous body made of the conductive carbon material. Thus, the conductive auxiliary agent added to the porous body can be eliminated or reduced by employing the porous body made of the conductive carbon material. Thus, the manufacturing cost for at least one of the positive electrode 10 and the negative electrode 20 can be reduced, and the degree of freedom of selection of the type and quantity of the conductive auxiliary agent can be increased.

### EXAMPLES

Specific examples of the present invention are now described. It is assumed that the electric double layer capacitor is charged for the first time from the charged state (constant current charge) in each of examples, reference examples, and comparative examples.

First, the electric double layer capacitor according to each of the examples, the reference examples, and the comparative examples was prepared.

Specifically, an activated carbon (YP50 manufactured by Kuraray Co., Ltd.), acetylene black, a dispersion of SBR, and a CMC aqueous solution were prepared as the porous bodies (the positive electrode side porous body and the negative electrode side porous body), the conductive auxiliary agent, the binder resin, and the binder, respectively.

Platinum electrodes obtained by sputtering platinum on a glass substrate were prepared as the positive electrode current body 11 and the negative electrode current body 21.

A polyolefin (MPF30AC100, aqueous, manufactured by Nippon Kodojushi Industrial Corporation) film having a thickness of 100 μm and a 10% sulfuric acid aqueous solution were prepared as the separator 30 and the electrolyte contained in the separator 30, respectively.

Then, 5 cc of ethanol to which 100 mg of the oxidation-reduction substance (the type of the oxidation-reduction substance in each of the examples, the reference examples, and the comparative examples is described later) and 100 mg of the porous bodies were added was slowly stirred all night by a rotator and was thereafter dried for 24 hours at 100° C., and the ethanol was extracted, whereby a powdery sample including the porous bodies on which the oxidation-reduction substance was adsorbed and immobilized was obtained.

Then, 40 mg of the obtained powdery sample (the porous bodies onto which the oxidation-reduction substance was adsorbed) or porous bodies (porous bodies onto which no oxidation-reduction substance was adsorbed) and 5 mg of the conductive auxiliary agent, the binder resin (12.5 μL) corresponding to 2.5 mg, and the binder (250 μL) corresponding to 2.5 mg were kneaded in a mortar, and the positive electrode active material slurry and the negative electrode active material slurry were prepared.

Then, the prepared positive electrode active material slurry was applied onto the positive electrode current collector 11 by a squeegee made of Teflon (registered trademark) and was naturally dried, and thereafter was dried for 12 hours at 100° C., whereby the positive electrode 10 was prepared. Furthermore, the prepared negative electrode active material slurry was applied onto the negative electrode current collector 21 by the squeegee made of Teflon (registered trademark) and was naturally dried, and thereafter was dried for 12 hours at 100° C., whereby the negative electrode 20 was prepared.

Then, the separator 30 soaked in the electrolyte was held between the prepared positive electrode 10 and the prepared negative electrode 20, whereby the electric double layer capacitor was prepared.

Then, the electrostatic capacity and the internal resistance of the prepared electric double layer capacitor according to each of the examples, the reference examples, and the comparative examples were measured. Specifically, a charge-discharge test was performed at a constant current of 7 mA/cm² with the prepared electric double layer capacitor.

Then, the cell capacity (electrostatic capacity) of the electric double layer capacitor was obtained from a portion of the obtained charging and discharging curve from 0.8 V to 0.2 V. Furthermore, the internal resistance of the electric double layer capacitor was obtained from the obtained charging and discharging curve.

### Example 1

As the electric double layer capacitor according to an example 1, an electric double layer capacitor in which 1,4-hydroquinone (HQ) expressed by the aforementioned formula (6) was adsorbed and immobilized as the oxidation-reduction substance on the positive electrode side porous body (activated carbon) included in the positive electrode active material layer and no oxidation-reduction substance was adsorbed and immobilized on the negative electrode side porous body included in the negative electrode active material layer was prepared, and the cell capacity and the internal resistance thereof were measured. The results are shown in a table 1.

### Comparative Example 0

As the electric double layer capacitor according to a comparative example 0, an electric double layer capacitor in which no oxidation-reduction substance was adsorbed and immobilized on the positive electrode side porous body or the negative electrode side porous body was prepared, and the cell capacity and the internal resistance thereof were measured. The results are also shown in the table 1.

### Reference Example 1-1

As the electric double layer capacitor according to a reference example 1-1, an electric double layer capacitor in which no oxidation-reduction substance was adsorbed and immobilized on the positive electrode side porous body and 1,4-hydroquinone (HQ) was adsorbed and immobilized as the oxidation-reduction substance on the negative electrode side porous body was prepared, and the cell capacity and the internal resistance thereof were measured. The results are also shown in the table 1.

### Reference Example 1-2

As the electric double layer capacitor according to a reference example 1-2, an electric double layer capacitor in which 1,4-hydroquinone (HQ) was adsorbed and immobilized as the oxidation-reduction substance on the positive electrode side porous body and the negative electrode side porous body was prepared, and the cell capacity and the internal resistance thereof were measured. The results are also shown in the table 1.

TABLE 1

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | YP50 | YP50 | 23.43 | 2.30 |
| Example 0 | | | | |
| Example 1 | HQ | YP50 | 50.00 | 1.06 |
| Reference | YP50 | HQ | 32.08 | 3.47 |
| Example 1-1 | | | | |
| Reference | HQ | HQ | 23.42 | 1.22 |
| Example 1-2 | | | | |

1,4-Hydroquinone (HQ) is a hydroquinone derivative in which all of R1 to R4 are hydrogen atoms in the hydroquinone derivative expressed by the aforementioned general formula (1). In other words, HQ is the oxidation-reduction substance in the reduced state. As shown in the table 1, it has been proved that in the case where HQ that is the oxidation-reduction substance in the reduced state is adsorbed onto the positive electrode side porous body and no oxidation-reduction substance is adsorbed onto the negative electrode side porous body (i.e. in the case of the “example 1”), the cell capacity is equal to or greater than twice that in the case where no oxidation-reduction substance is adsorbed onto the positive electrode side porous body or the negative electrode side porous body (i.e. in the case of the “comparative example 0”).

Thus, in the case where the capacitor is charged for the first time from the discharged state (constant current charge), it has been proved that the capacity of the electric double layer capacitor can be increased by adsorbing the oxidation-reduction substance in the reduced state onto the positive electrode side porous body included in the positive electrode active material layer.

Furthermore, it has been proved that in the case where HQ is adsorbed onto only the positive electrode side porous body (i.e. in the case of the “example 1”), the cell capacity is higher than those in the case where HQ is adsorbed onto only the negative electrode side porous body (i.e. in the case of the “reference example 1-1”) and in the case where HQ is adsorbed onto both the positive electrode side porous body and the negative electrode side porous body (i.e. in the case of the “reference example 1-2”).

Therefore, it can be confirmed that HQ is in the oxidized state when the capacitor is charged such that current flows from the electrode including the porous body onto which HQ is adsorbed to the electrode (activated carbon electrode) in which the porous body is the activated carbon and the pseudo-capacity is developed. Thus, it has been proved that the oxidation-reduction substance in the reduced state is preferably introduced into the positive electrode active material layer in the case where the capacitor is charged for the first time from the discharged state (constant current charge).

### Example 2

As the electric double layer capacitor according to an example 2, an electric double layer capacitor in which no oxidation-reduction substance was adsorbed and immobilized on the positive electrode side porous body included in the positive electrode active material layer and 2,5-dihydroxy-1,4-benzoquinone (BQ) expressed by the aforementioned formula (8) was adsorbed and immobilized as the oxidation-reduction substance on the negative electrode side porous body included in the negative electrode active material layer was prepared, and the cell capacity and the internal resistance thereof were measured. The results are shown in a table 2.

### Reference Example 2-1

As the electric double layer capacitor according to a reference example 2-1, an electric double layer capacitor in which 2,5-dihydroxy-1,4-benzoquinone (BQ) was adsorbed and immobilized as the oxidation-reduction substance on the positive electrode side porous body and no oxidation-reduction substance was adsorbed and immobilized on the negative electrode side porous body was prepared, and the cell capacity and the internal resistance thereof were measured. The results are also shown in the table 2.

### Reference Example 2-2

As the electric double layer capacitor according to a reference example 2-2, an electric double layer capacitor in which 2,5-dihydroxy-1,4-benzoquinone (BQ) was adsorbed and immobilized as the oxidation-reduction substance on the positive electrode side porous body and the negative electrode side porous body was prepared, and the cell capacity and the internal resistance thereof were measured. The results are also shown in the table 2.

### Example 3

As the electric double layer capacitor according to an example 3, an electric double layer capacitor in which no oxidation-reduction substance was adsorbed and immobilized on the positive electrode side porous body and 2,5-dimethoxy-1,4-benzoquinone (DEBQ) expressed by the aforementioned formula (9) was adsorbed and immobilized as the oxidation-reduction substance on the negative electrode side porous body was prepared, and the cell capacity and the internal resistance thereof were measured. The results are also shown in the table 2.

### Reference Example 3-1

As the electric double layer capacitor according to a reference example 3-1, an electric double layer capacitor in which 2,5-dimethoxy-1,4-benzoquinone (DEBQ) was adsorbed and immobilized as the oxidation-reduction substance on the positive electrode side porous body and no oxidation-reduction substance was adsorbed and immobilized on the negative electrode side porous body was prepared, and the cell capacity and the internal resistance thereof were measured. The results are also shown in the table 2.

### Reference Example 3-2

As the electric double layer capacitor according to a reference example 3-2, an electric double layer capacitor in which 2,5-dimethoxy-1,4-benzoquinone (DEBQ) was adsorbed and immobilized as the oxidation-reduction substance on the positive electrode side porous body and the negative electrode side porous body was prepared, and the cell capacity and the internal resistance thereof were measured. The results are also shown in the table 2.

TABLE 2

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | YP50 | YP50 | 23.43 | 2.30 |
| Example 0 | | | | |
| Example 2 | YP50 | BQ | 55.91 | 3.01 |
| Reference | BQ | YP50 | 16.13 | 2.88 |
| Example 2-1 | | | | |
| Reference | BQ | BQ | 30.56 | 0.64 |
| Example 2-2 | | | | |
| Example 3 | YP50 | DEBQ | 41.11 | 2.99 |
| Reference | DEBQ | YP50 | 12.51 | 2.09 |
| Example 3-1 | | | | |
| Reference | DEBQ | DEBQ | 10.23 | 1.91 |
| Example 3-2 | | | | |

2,5-Dihydroxy-1,4-benzoquinone (BQ) is a benzoquinone derivative in which R21 and R24 are hydroxyl groups and R22 and R23 are hydrogen atoms in the benzoquinone derivative expressed by the aforementioned general formula (4). In other words, BQ is the oxidation-reduction substance in the oxidized state.

Furthermore, 2,5-dimethoxy-1,4-benzoquinone (DEBQ) is a benzoquinone derivative in which R21 and R24 are alkoxy groups and R22 and R23 are hydrogen atoms in the benzoquinone derivative expressed by the aforementioned general formula (4). In other words, DEBQ is the oxidation-reduction substance in the oxidized state.

As shown in the table 2, it has been proved that in the case where BQ that is the oxidation-reduction substance in the oxidized state is adsorbed onto the negative electrode side porous body included in the negative electrode active material layer and no oxidation-reduction substance is adsorbed onto the positive electrode side porous body included in the positive electrode active material layer (i.e. in the case of the “example 2”), the cell capacity is equal to or greater than twice that in the case where no oxidation-reduction substance is adsorbed onto the positive electrode side porous body or the negative electrode side porous body (i.e. in the case of the “comparative example 0”).

Furthermore, it has been proved that in the case where DEBQ that is the oxidation-reduction substance in the oxidized state is adsorbed onto the negative electrode side porous body and no oxidation-reduction substance is adsorbed onto the positive electrode side porous body (i.e. in the case of the “example 3”), the cell capacity is equal to or greater than 1.75 times that in the case where no oxidation-reduction substance is adsorbed onto the positive electrode side porous body or the negative electrode side porous body (i.e. in the case of the “comparative example 0”).

Thus, in the case where the capacitor is charged for the first time from the discharged state (constant current charge), it has been proved that the capacity of the electric double layer capacitor can be increased by adsorbing the oxidation-reduction substance in the oxidized state onto the negative electrode side porous body included in the negative electrode active material layer.

Furthermore, it has been proved that in the case where BQ or DEBQ is adsorbed onto only the negative electrode side porous body (i.e. in the case of the “example 2” or the “Example 3”), the cell capacity is higher than those in the case where BQ or DEBQ is adsorbed onto only the positive electrode side porous body (i.e. in the case of the “reference example 2-1” or the “reference example 3-1”) and in the case where BQ or DEBQ is adsorbed onto both the positive electrode side porous body and the negative electrode side porous body (i.e. in the case of the “reference example 2-2” or the “reference example 3-2”).

Therefore, it can be confirmed that BQ or DEBQ is in the reduced state when the capacitor is charged such that current flows from the activated carbon electrode to the electrode including the porous body onto which BQ or DEBQ is adsorbed and the pseudo-capacity is developed. Thus, it has been proved that the oxidation-reduction substance in the oxidized state is preferably introduced into the negative electrode active material layer in the case where the capacitor is charged for the first time from the discharged state (constant current charge).

### Example 4

As the electric double layer capacitor according to an example 4, an electric double layer capacitor in which no oxidation-reduction substance was adsorbed and immobilized on the positive electrode side porous body included in the positive electrode active material layer and 5,7,12,14-pentacenetetrone (PCT) expressed by the aforementioned formula (12) was adsorbed and immobilized as the oxidation-reduction substance on the negative electrode side porous body included in the negative electrode active material layer was prepared, and the cell capacity and the internal resistance thereof were measured. The results are shown in a table 3.

### Reference Example 4-1

As the electric double layer capacitor according to a reference example 4-1, an electric double layer capacitor in which 5,7,12,14-pentacenetetrone (PCT) was adsorbed and immobilized as the oxidation-reduction substance on the positive electrode side porous body and no oxidation-reduction substance was adsorbed and immobilized on the negative electrode side porous body was prepared, and the cell capacity and the internal resistance thereof were measured. The results are also shown in the table 3.

### Reference Example 4-2

As the electric double layer capacitor according to a reference example 4-2, an electric double layer capacitor in which 5,7,12,14-pentacenetetrone (PCT) was adsorbed and immobilized as the oxidation-reduction substance on the positive electrode side porous body and the negative electrode side porous body was prepared, and the cell capacity and the internal resistance thereof were measured. The results are also shown in the table 3.

TABLE 3

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | YP50 | YP50 | 23.43 | 2.30 |
| Example 0 | | | | |
| Example 4 | YP50 | PCT | 50.20 | 1.52 |
| Reference | PCT | YP50 | 8.01 | 2.25 |
| Example 4-1 | | | | |
| Reference | PCT | PCT | 0.77 | 3.61 |
| Example 4-2 | | | | |

5,7,12,14-Pentacenetetrone (PCT) is a ring-expanded benzoquinone derivative obtained by ring-expanding the benzoquinone derivative expressed by the aforementioned general formula (4). In other words, PCT is the oxidation-reduction substance in the oxidized state.

As shown in the table 3, it has been proved that in the case where PCT that is the oxidation-reduction substance in the oxidized state is adsorbed onto the negative electrode side porous body included in the negative electrode active material layer and no oxidation-reduction substance is adsorbed onto the positive electrode side porous body included in the positive electrode active material layer (i.e. in the case of the “example 4”), the cell capacity is equal to or greater than twice that in the case where no oxidation-reduction substance is adsorbed onto the positive electrode side porous body or the negative electrode side porous body (i.e. in the case of the “comparative example 0”).

Thus, in the case where the capacitor is charged for the first time from the discharged state (constant current charge), it has been proved that the capacity of the electric double layer capacitor can be increased by adsorbing the oxidation-reduction substance in the oxidized state onto the negative electrode side porous body included in the negative electrode active material layer.

Furthermore, it has been proved that in the case where PCT is adsorbed onto only the negative electrode side porous body (i.e. in the case of the “example 4”), the cell capacity is higher than those in the case where PCT is adsorbed onto only the positive electrode side porous body (i.e. in the case of the “reference example 4-1”) and in the case where PCT is adsorbed onto both the positive electrode side porous body and the negative electrode side porous body (i.e. in the case of the “reference example 4-2”).

Therefore, it can be confirmed that PCT is in the reduced state when the capacitor is charged such that current flows from the activated carbon electrode to the electrode including the porous body onto which PCT is adsorbed and the pseudo-capacity is developed. Thus, it has been proved that the oxidation-reduction substance in the oxidized state is preferably introduced into the negative electrode active material layer in the case where the capacitor is charged for the first time from the discharged state (constant current charge).

### Example 5-1

As the electric double layer capacitor according to an example 5-1, an electric double layer capacitor in which 1,4-hydroquinone (HQ) was adsorbed as the oxidation-reduction substance onto the positive electrode side porous body included in the positive electrode active material layer and 2,5-dihydroxy-1,4-benzoquinone (BQ) was adsorbed and immobilized as the oxidation-reduction substance on the negative electrode side porous body included in the negative electrode active material layer was prepared, and the cell capacity and the internal resistance thereof were measured. The results are shown in a table 4.

### Example 5-2

As the electric double layer capacitor according to an example 5-2, an electric double layer capacitor in which 1,4-hydroquinone (HQ) was adsorbed as the oxidation-reduction substance onto the positive electrode side porous body and 5,7,12,14-pentacenetetrone (PCT) was adsorbed and immobilized as the oxidation-reduction substance on the negative electrode side porous body was prepared, and the cell capacity and the internal resistance thereof were measured. The results are also shown in the table 4.

### Example 5-3

As the electric double layer capacitor according to an example 5-3, an electric double layer capacitor in which 1,4-hydroquinone (HQ) was adsorbed as the oxidation-reduction substance onto the positive electrode side porous body and 2,5-dimethoxy-1,4-benzoquinone (DEBQ) was adsorbed and immobilized as the oxidation-reduction substance on the negative electrode side porous body was prepared, and the cell capacity and the internal resistance thereof were measured. The results are also shown in the table 4.

### Reference Example 5-1

As the electric double layer capacitor according to a reference example 5-1, an electric double layer capacitor in which 2,5-dihydroxy-1,4-benzoquinone (BQ) was adsorbed as the oxidation-reduction substance on the positive electrode side porous body and 1,4-hydroquinone (HQ) was adsorbed and immobilized as the oxidation-reduction substance on the negative electrode side porous body was prepared, and the cell capacity and the internal resistance thereof were measured. The results are also shown in the table 4.

TABLE 4

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | YP50 | YP50 | 23.43 | 2.30 |
| Example 0 | | | | |
| Example 5-1 | HQ | BQ | 76.17 | 2.60 |
| Example 5-2 | HQ | PCT | 50.69 | 2.26 |
| Example 5-3 | HQ | DEBQ | 59.72 | 3.22 |
| Reference | PCT | HQ | 21.57 | 4.18 |
| Example 5-1 | | | | |

As shown in the table 4, it has been proved that in the case where HQ that is the oxidation-reduction substance in the reduced state effectively causing the oxidation-reduction reaction when the electric double layer capacitor is charged and discharged is adsorbed onto the positive electrode side porous body included in the positive electrode active material layer and BQ, PCT, or DEBQ that is the oxidation-reduction substance in the oxidized state effectively causing the oxidation-reduction reaction when the electric double layer capacitor is charged and discharged is adsorbed onto the negative electrode side porous body included in the negative electrode active material layer (i.e. in the case of the “example 5-1”, the “example 5-2”, or the “example 5-3”), the cell capacity is equal to or greater than twice that in the case where no oxidation-reduction substance is adsorbed onto the positive electrode side porous body or the negative electrode side porous body (i.e. in the case of the “comparative example 0”). Particularly in the case where HQ is adsorbed onto the positive electrode side porous body and BQ is adsorbed onto the negative electrode side porous body (i.e. in the case of the “example 5-1”), it has been proved that the cell capacity is equal to or greater than three times that in the case of the “comparative example 0”.

Furthermore, it has been proved that in the case where the oxidation-reduction substance (BQ) in the oxidized state is adsorbed onto the positive electrode side porous body and the oxidation-reduction substance (HQ) in the reduced state is adsorbed onto the negative electrode side porous body (i.e. in the case of the “reference example 5-1”), the cell capacity is not increased as compared with the case of the “comparative example 0”.

Thus, in the case where the capacitor is charged for the first time from the discharged state (constant current charge), it has been proved that the capacity of the electric double layer capacitor can be increased by adsorbing the oxidation-reduction substance in the reduced state onto the positive electrode side porous body included in the positive electrode active material layer and adsorbing the oxidation-reduction substance in the oxidized state onto the negative electrode side porous body included in the negative electrode active material layer.

### Example 6

As the electric double layer capacitor according to an example 6, an electric double layer capacitor in which 1,2-napthoquinone-4-sulfonic acid sodium salt (NQ) expressed by the aforementioned formula (11) was adsorbed as the oxidation-reduction substance onto the positive electrode side porous body included in the positive electrode active material layer and 2,5-dihydroxy-1,4-benzoquinone (BQ) was adsorbed and immobilized as the oxidation-reduction substance on the negative electrode side porous body included in the negative electrode active material layer was prepared, and the cell capacity and the internal resistance thereof were measured. The results are shown in a table 5.

### Reference Example 6

As the electric double layer capacitor according to a reference example 6, an electric double layer capacitor in which 2,5-dihydroxy-1,4-benzoquinone (BQ) was adsorbed as the oxidation-reduction substance onto the positive electrode side porous body and 1,2-napthoquinone-4-sulfonic acid sodium salt (NQ) was adsorbed and immobilized as the oxidation-reduction substance on the negative electrode side porous body was prepared, and the cell capacity and the internal resistance thereof were measured. The results are also shown in the table 5.

TABLE 5

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | YP50 | YP50 | 23.43 | 2.30 |
| Example 0 | | | | |
| Example 6 | NQ | BQ | 38.75 | 2.53 |
| Reference | BQ | NQ | 26.45 | 6.28 |
| Example 6 | | | | |

1,2-Napthoquinone-4-sulfonic acid sodium salt (NQ) is a benzoquinone derivative in which R25 is a hydrogen atom, R26 is a sulfonic acid group (sodium salt), and a set of R27 and R28 is fused to each other to form a six member fused ring in the benzoquinone derivative expressed by the aforementioned general formula (5). In other words, NQ is the oxidation-reduction substance in the oxidized state.

2,5-Dihydroxy-1,4-benzoquinone (BQ) is the benzoquinone derivative in which R21 and R24 are hydroxyl groups and R22 and R23 are hydrogen atoms in the benzoquinone derivative expressed by the aforementioned general formula (4). In other words, BQ is the oxidation-reduction substance in the oxidized state.

The oxidation-reduction potential of NQ is higher than the oxidation-reduction potential of BQ.

As shown in the table 5, when the benzoquinone derivative is adsorbed onto the positive electrode side porous body included in the positive electrode active material layer and the negative electrode side porous body included in the negative electrode active material layer, it has been proved that in the case where NQ having higher oxidation-reduction potential than BQ is adsorbed onto the positive electrode side porous body and BQ having lower oxidation-reduction potential than NQ is adsorbed onto the negative electrode side porous body (i.e. in the case of the “example 6”), the cell capacity is higher than that in the case where BQ having the lower oxidation-reduction potential is adsorbed onto the positive electrode side porous body and NQ having the higher oxidation-reduction potential is adsorbed onto the negative electrode side porous body (i.e. in the case of the “reference example 6”).

Furthermore, it has been proved that in the case where NQ having the higher oxidation-reduction potential is adsorbed onto the positive electrode side porous body and BQ having the lower oxidation-reduction potential is adsorbed onto the negative electrode side porous body (i.e. in the case of the “example 6”), the cell capacity is equal to or greater than 1.65 times that in the case where no oxidation-reduction substance is adsorbed onto the positive electrode side porous body or the negative electrode side porous body (i.e. in the case of the “comparative example 0”).

Thus, it has been proved that the oxidation-reduction substance in the same state (the oxidized state or the reduced state) may be adsorbed onto both the positive electrode side porous body included in the positive electrode active material layer and the negative electrode side porous body included in the negative electrode active material layer, and at this time, the capacity of the electric double layer capacitor can be increased by adsorbing the oxidation-reduction substance having the higher oxidation-reduction potential onto the positive electrode side porous body and adsorbing the oxidation-reduction substance having the lower oxidation-reduction potential onto the negative electrode side porous body.

An example of the charging and discharging curve of the electric double layer capacitor according to the “comparative example 0” and an example of the charging and discharging curve of the electric double layer capacitor according to the “example 5-1” in which the cell capacity is the highest among the aforementioned examples are shown in FIG. 5.

As shown by a solid line in FIG. 5, it has been proved that the charging and discharging curve of the electric double layer capacitor according to the “example 5-1” is largely curved at a voltage of about 0.3 V and the oxidation-reduction reaction (redox reaction) is caused. Furthermore, it has been proved that a high capacity of about 190 F/g is obtained if the cell capacity of the electric double layer capacitor according to the “example 5-1” in a low voltage region (0.4 V→0.2 V) is obtained from this charging and discharging curve.

### Comparative Example 7-1

As the electric double layer capacitor according to a comparative example 7-1, an electric double layer capacitor in which the positive electrode active material layer included no porous body but included 1,4-hydroquinone (HQ) in a state where 1,4-hydroquinone (HQ) was not adsorbed and immobilized as the oxidation-reduction substance on a porous body and no oxidation-reduction substance was adsorbed and immobilized onto the negative electrode side porous body included in the negative electrode active material layer was prepared, and the cell capacity and the internal resistance thereof were measured. The results are shown in a table 6.

### Comparative Example 7-2

As the electric double layer capacitor according to a comparative example 7-2, an electric double layer capacitor in which the positive electrode side porous body included in the positive electrode active material layer included no oxidation-reduction substance and the negative electrode active material layer included no porous body but included 2,5-dihydroxy-1,4-benzoquinone (BQ) in a state where 2,5-dihydroxy-1,4-benzoquinone (BQ) was not adsorbed and immobilized as the oxidation-reduction substance on a porous body was prepared, and the cell capacity and the internal resistance thereof were measured. The results are also shown in the table 6.

TABLE 6

| | | | | Internal |
|---|---|---|---|---|
| | | | Cell Capacity | Resistance |
| | | | by Charge- | by Charge- |
| | Positive | Negative | Discharge Test | Discharge Test |
| | Electrode | Electrode | [F/g] | [Ω/mm²] |
| Comparative | HQ | YP50 | 38.24 | 1.95 |
| Example 7-1 | (not | | | |
| | including | | | |
| | YP50) | | | |
| Comparative | YP50 | BQ | 3.90 | 14.28 |
| Example 7-2 | | (not | | |
| | | including | | |
| | | YP50) | | |

As shown in the table 6, it has been proved that in the case where the positive electrode active material layer includes no porous body but includes HQ that is the oxidation-reduction substance in the reduced state in a state where HQ is not adsorbed and immobilized on a porous body (i.e. in the case of the “comparative example 7-1”), the cell capacity is lower than that in the case where the positive electrode active material layer includes HQ that is the oxidation-reduction substance in the reduced state in a state where HQ is adsorbed and immobilized on the positive electrode side porous body (i.e. in the case of the “example 1” in the table 1).

Furthermore, it has been proved that in the case where the negative electrode active material layer includes no porous body but includes BQ that is the oxidation-reduction substance in the oxidized state in a state where BQ is not adsorbed and immobilized on a porous body (i.e. in the case of the “comparative example 7-2”), the cell capacity is lower than that in the case where the negative electrode active material layer includes BQ that is the oxidation-reduction substance in the oxidized state in a state where BQ is adsorbed and immobilized on the negative electrode side porous body (i.e. in the case of the “example 2” in the table 2).

Thus, it has been proved that not only an effect of increasing the capacity by formation of the electric double layer on a surface of the porous body having a large specific surface area but also an effect of increasing the capacity by addition of the pseudo-capacity caused by the oxidation-reduction reaction of the oxidation-reduction substance can be obtained in the case where the oxidation-reduction substance is not directly introduced into the active material layer as the active material but is introduced thereinto in a state of being adsorbed onto the porous body, so that the capacity of the electric double layer capacitor can be increased.

### Comparative Example 8-1

As the electric double layer capacitor according to a comparative example 8-1, an electric double layer capacitor in which no oxidation-reduction substance was adsorbed and immobilized onto the positive electrode side porous body included in the positive electrode active material layer or the negative electrode side porous body included in the negative electrode active material layer and 1,4-hydroquinone (HQ) was added to the electrolyte contained in the separator 30 was prepared, and the cell capacity and the internal resistance thereof were measured. The results are shown in a table 7.

### Comparative Example 8-2

As the electric double layer capacitor according to a comparative example 8-2, an electric double layer capacitor in which no oxidation-reduction substance was adsorbed and immobilized onto the positive electrode side porous body or the negative electrode side porous body and 1,4-hydroquinone (HQ) and 2,5-dihydroxy-1,4-benzoquinone (BQ) were added to the electrolyte contained in the separator 30 was prepared, and the cell capacity and the internal resistance thereof were measured. The results are also shown in the table 7.

TABLE 7

| | | | | Cell | Internal |
|---|---|---|---|---|---|
| | Posi- | Nega- | | Capacity | Resistance |
| | tive | tive | | by Charge- | by Charge- |
| | Elec- | Elec- | Additive | Discharge | Discharge |
| | trode | trode | Agent | Test [F/g] | Test [Ω/mm²] |
| Comparative | YP50 | YP50 | None | 23.43 | 2.30 |
| Example 0 | | | | | |
| Comparative | YP50 | YP50 | HQ | 19.90 | 1.45 |
| Example 8-1 | | | | | |
| Comparative | YP50 | YP50 | HQ + BQ | 22.39 | 1.48 |
| Example 8-2 | | | | | |

As shown in the table 7, it has been proved that in the case where no oxidation-reduction substance is adsorbed onto the positive electrode side porous body or the negative electrode side porous body and the oxidation-reduction substance is added to the electrolyte (i.e. in the case of the “comparative example 8-1” or the “comparative example 8-2”), the cell capacity is rarely different from that in the case where no oxidation-reduction substance is added to the electrolyte (i.e. in the case of the “comparative example 0”).

Thus, it has been proved that the oxidation-reduction reaction is effectively caused by the oxidation-reduction substance and the capacity of the electric double layer capacitor can be increased in the case where the oxidation-reduction substance is not used with addition to the electrolyte but is used in a state of being adsorbed onto the porous bodies as the active material.

Electric double layer capacitors according to an example 9 and a reference example 9 were prepared, employing oxidized nicotinamide adenine dinucleotide (NAD⁺) as the oxidation-reduction substance.

The electric double layer capacitors according to the example 9 and the reference example 9 are different only in a way of preparing a powdery sample (i.e. porous bodies onto which NAD⁺ is adsorbed) from the electric double layer capacitors according to the aforementioned examples 1 to 6, the reference examples 1 to 6, and the comparative examples 7 and 8.

Specifically, according to the example 9 and the reference example 9, 4 cc of a phosphate buffer solution to which 20 mg of oxidized nicotinamide adenine dinucleotide (NAD⁺) and 80 mg of porous bodies were added was slowly stirred all night by the rotator and was thereafter centrifuged, and the supernatant solution was discarded. Then, the precipitate was cleaned with water once and with ethanol twice and was centrifuged. Then, the obtained mixed solution was dried for 24 hours, and the ethanol was extracted, whereby the powdery sample (the porous bodies onto which NAD⁺ was adsorbed) was obtained.

### Example 9

As the electric double layer capacitor according to the example 9, an electric double layer capacitor in which no oxidation-reduction substance was adsorbed and immobilized onto the positive electrode side porous body included in the positive electrode active material layer and oxidized nicotinamide adenine dinucleotide (NAD⁺) was adsorbed and immobilized as the oxidation-reduction substance on the negative electrode side porous body included in the negative electrode active material layer was prepared, and the cell capacity and the internal resistance thereof were measured. The results are shown in a table 8.

### Reference Example 9

As the electric double layer capacitor according to the reference example 9, an electric double layer capacitor in which oxidized nicotinamide adenine dinucleotide (NAD⁺) was adsorbed and immobilized as the oxidation-reduction substance on the positive electrode side porous body and no oxidation-reduction substance was adsorbed and immobilized onto the negative electrode side porous body was prepared, and the cell capacity and the internal resistance thereof were measured. The results are also shown in the table 8.

TABLE 8

| | | | | Internal |
|---|---|---|---|---|
| | | | Cell Capacity | Resistance |
| | | | by Charge- | by Charge- |
| | Positive | Negative | Discharge | Discharge |
| | Electrode | Electrode | Test [F/g] | Test [Ω/mm²] |
| Comparative | YP50 | YP50 | 23.43 | 2.30 |
| Example 0 | | | | |
| Example 9 | YP50 | NAD⁺ | 31.14 | 1.70 |
| Reference | NAD⁺ | YP50 | 26.17 | 0.81 |
| Example 9 | | | | |

NAD⁺ is the oxidation-reduction substance in the oxidized state, as shown in FIG. 4.

As shown in the table 8, it has been proved that in the case where NAD⁺ that is the oxidation-reduction substance in the oxidized state is adsorbed onto the negative electrode side porous body included in the negative electrode active material layer and no oxidation-reduction substance is adsorbed onto the positive electrode side porous body included in the positive electrode active material layer (i.e. in the case of the “example 9”), the cell capacity is equal to or greater than 1.3 times that in the case where no oxidation-reduction substance is adsorbed onto the positive electrode side porous body or the negative electrode side porous body (i.e. in the case of the “comparative example 0”).

Thus, in the case where the capacitor is charged for the first time from the discharged state (constant current charge), it has been proved that the capacity of the electric double layer capacitor can be increased by adsorbing the oxidation-reduction substance in the oxidized state onto the negative electrode side porous body.

Furthermore, it has been proved that in the case where NAD⁺ is adsorbed onto only the negative electrode side porous body (i.e. in the case of the “example 9”), the cell capacity is higher than that in the case where NAD⁺ is adsorbed onto only the positive electrode side porous body (i.e. in the case of the “reference example 9”).

Therefore, it can be confirmed that NAD⁺ is in the reduced state when the capacitor is charged such that current flows from the activated carbon electrode to the electrode including the porous body onto which NAD⁺ is adsorbed and the pseudo-capacity is developed. Thus, it has been proved that the oxidation-reduction substance in the oxidized state is preferably introduced into the negative electrode active material layer in the case where the capacitor is charged for the first time from the discharged state (constant current charge).

The embodiment and examples disclosed this time must be considered as illustrative in all points and not restrictive. The range of the present invention is shown not by the above description of the embodiment and examples but by the scope of claims for patent, and all modifications within the meaning and range equivalent to the scope of claims for patent are further included.

What is claimed is:

1. An electric double layer capacitor electrode comprising:
a positive electrode having a positive electrode active material layer including a positive electrode side porous body; and
a negative electrode having a negative electrode active material layer including a negative electrode side porous body, wherein
an oxidation-reduction substance causing an oxidation-reduction reaction during charging and discharging is adsorbed onto at least one of the positive electrode side porous body of the positive electrode active material layer and the negative electrode side porous body of the negative electrode active material layer.

2. The electric double layer capacitor electrode according to claim 1, wherein
the oxidation-reduction substance changing from a reduced state to an oxidized state due to an oxidation reaction during charging and changing from the oxidized state to the reduced state due to a reduction reaction during discharging is adsorbed onto the positive electrode side porous body.

3. The electric double layer capacitor electrode according to claim 1, wherein
the oxidation-reduction substance changing from an oxidized state to a reduced state due to a reduction reaction during charging and changing from the reduced state to the oxidized state due to an oxidation reaction during discharging is adsorbed onto the negative electrode side porous body.

4. The electric double layer capacitor electrode according to claim 1, wherein
the oxidation-reduction substance changing from a reduced state to an oxidized state due to an oxidation reaction during charging and changing from the oxidized state to the reduced state due to a reduction reaction during discharging is adsorbed onto the positive electrode side porous body, and
the oxidation-reduction substance changing from the oxidized state to the reduced state due to the reduction reaction during charging and changing from the reduced state to the oxidized state due to the oxidation reaction during discharging is adsorbed onto the negative electrode side porous body.

5. The electric double layer capacitor electrode according to claim 1, wherein
the oxidation-reduction substance is adsorbed onto the negative electrode side porous body, and
the oxidation-reduction substance having higher oxidation-reduction potential than the oxidation-reduction substance adsorbed onto the negative electrode side porous body is adsorbed onto the positive electrode side porous body.

6. The electric double layer capacitor electrode according to claim 1, wherein
the oxidation-reduction substance adsorbed onto at least one of the positive electrode side porous body and the negative electrode side porous body includes an oxidation-reduction substance capable of causing a multi-electron oxidation-reduction reaction involving movement of a plurality of electrons.

7. The electric double layer capacitor electrode according to claim 1, wherein
the oxidation-reduction substance adsorbed onto at least one of the positive electrode side porous body and the negative electrode side porous body has a functional group in which a ketone group becomes a reduced hydroxyl group in a reduced state and a hydroxyl group becomes an oxidized ketone group in an oxidized state.

8. The electric double layer capacitor electrode according to claim 7, wherein
the oxidation-reduction substance adsorbed onto at least one of the positive electrode side porous body and the negative electrode side porous body comprises an oxidation-reduction substance selected from a hydroquinone derivative expressed by a following general formula (1), a catechol derivative expressed by a following general formula (2), a resorcinol derivative expressed by a following general formula (3), a benzoquinone derivative expressed by a following general formula (4), and a benzoquinone derivative expressed by a following general formula (5): 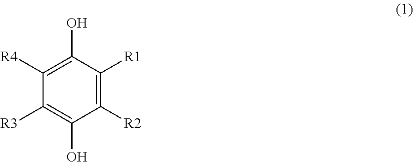
where R1, R2, R3, and R4 represent groups selected from a hydrogen atom, an alkyl group, an aryl group, an alkoxy group, a hydroxyl group, a nitro group, an alkyl carbonyl group, a formyl group, a sulfonic acid group (part or all may form a cation and a salt), a carboxyl group, and an alkoxycarbonyl group, or at least one of a set of R1 and R2 and a set of R3 and R4 may be fused to each other to form a five or six member fused ring; 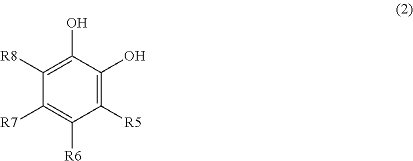
where R5, R6, R7, and R8 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R5 and R6, a set of R6 and R7, and a set of R7 and R8 may be fused to each other to form the five or six member fused ring; 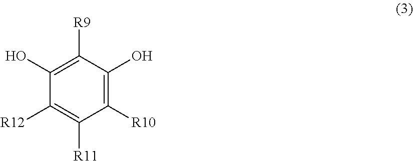
where R9, R10, R11, and R12 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or one of a set of R10 and R11 and a set of R11 and R12 may be fused to each other to form the five or six member fused ring; 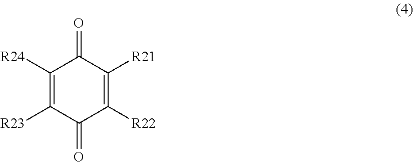
where R21, R22, R23, and R24 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R21 and R22 and a set of R23 and R24 may be fused to each other to form the five or six member fused ring; and 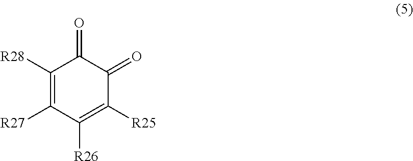
where R25, R26, R27, and R28 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R25 and R26, a set of R26 and R27, and a set of R27 and R28 may be fused to each other to form the five or six member fused ring.

9. The electric double layer capacitor electrode according to claim 1, wherein
the oxidation-reduction substance adsorbed onto at least one of the positive electrode side porous body and the negative electrode side porous body comprises an oxidation-reduction substance selected from a quinone coenzyme and a vitamin coenzyme causing the oxidation-reduction reaction during charging and discharging.

10. The electric double layer capacitor electrode according to claim 1, wherein
at least one of the positive electrode side porous body and the negative electrode side porous body is made of conductive carbon material.

11. An electric double layer capacitor comprising:
a positive electrode having a positive electrode active material layer including a positive electrode side porous body; and
a negative electrode having a negative electrode active material layer including a negative electrode side porous body, wherein
an oxidation-reduction substance causing an oxidation-reduction reaction during charging and discharging is adsorbed onto at least one of the positive electrode side porous body of the positive electrode active material layer and the negative electrode side porous body of the negative electrode active material layer.

12. The electric double layer capacitor according to claim 11, wherein
the oxidation-reduction substance changing from a reduced state to an oxidized state due to an oxidation reaction during charging and changing from the oxidized state to the reduced state due to a reduction reaction during discharging is adsorbed onto the positive electrode side porous body.

13. The electric double layer capacitor according to claim 11, wherein
the oxidation-reduction substance changing from an oxidized state to a reduced state due to a reduction reaction during charging and changing from the reduced state to the oxidized state due to an oxidation reaction during discharging is adsorbed onto the negative electrode side porous body.

14. The electric double layer capacitor according to claim 11, wherein
the oxidation-reduction substance changing from a reduced state to an oxidized state due to an oxidation reaction during charging and changing from the oxidized state to the reduced state due to a reduction reaction during discharging is adsorbed onto the positive electrode side porous body, and
the oxidation-reduction substance changing from the oxidized state to the reduced state due to the reduction reaction during charging and changing from the reduced state to the oxidized state due to the oxidation reaction during discharging is adsorbed onto the negative electrode side porous body.

15. The electric double layer capacitor according to claim 11, wherein
the oxidation-reduction substance is adsorbed onto the negative electrode side porous body, and
the oxidation-reduction substance having higher oxidation-reduction potential than the oxidation-reduction substance adsorbed onto the negative electrode side porous body is adsorbed onto the positive electrode side porous body.

16. The electric double layer capacitor according to claim 11, wherein
the oxidation-reduction substance adsorbed onto at least one of the positive electrode side porous body and the negative electrode side porous body includes an oxidation-reduction substance capable of causing a multi-electron oxidation-reduction reaction involving movement of a plurality of electrons.

17. The electric double layer capacitor according to claim 11, wherein
the oxidation-reduction substance adsorbed onto at least one of the positive electrode side porous body and the negative electrode side porous body has a functional group in which a ketone group becomes a reduced hydroxyl group in a reduced state and a hydroxyl group becomes an oxidized ketone group in an oxidized state.

18. The electric double layer capacitor according to claim 17, wherein
the oxidation-reduction substance adsorbed onto at least one of the positive electrode side porous body and the negative electrode side porous body comprises an oxidation-reduction substance selected from a hydroquinone derivative expressed by a following general formula (1), a catechol derivative expressed by a following general formula (2), a resorcinol derivative expressed by a following general formula (3), a benzoquinone derivative expressed by a following general formula (4), and a benzoquinone derivative expressed by a following general formula (5): 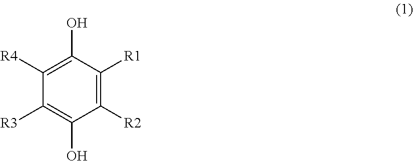
where R1, R2, R3, and R4 represent groups selected from a hydrogen atom, an alkyl group, an aryl group, an alkoxy group, a hydroxyl group, a nitro group, an alkyl carbonyl group, a formyl group, a sulfonic acid group (part or all may form a cation and a salt), a carboxyl group, and an alkoxycarbonyl group, or at least one of a set of R1 and R2 and a set of R3 and R4 may be fused to each other to form a five or six member fused ring; 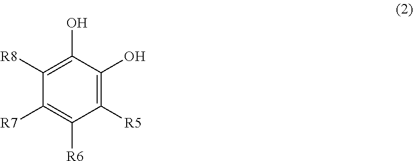
where R5, R6, R7, and R8 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R5 and R6, a set of R6 and R7, and a set of R7 and R8 may be fused to each other to form the five or six member fused ring; 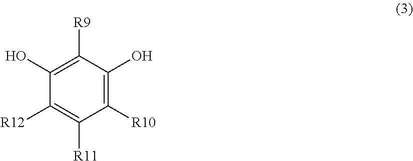
where R9, R10, R11, and R12 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or one of a set of R10 and R11 and a set of R11 and R12 may be fused to each other to form the five or six member fused ring; 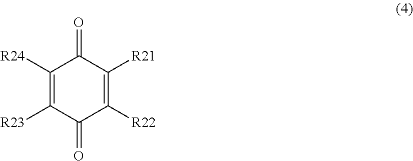
where R21, R22, R23, and R24 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R21 and R22 and a set of R23 and R24 may be fused to each other to form the five or six member fused ring; and 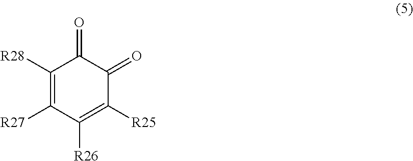
where R25, R26, R27, and R28 represent groups selected from the hydrogen atom, the alkyl group, the aryl group, the alkoxy group, the hydroxyl group, the nitro group, the alkyl carbonyl group, the formyl group, the sulfonic acid group (part or all may form the cation and the salt), the carboxyl group, and the alkoxycarbonyl group, or at least one of a set of R25 and R26, a set of R26 and R27, and a set of R27 and R28 may be fused to each other to form the five or six member fused ring.

19. The electric double layer capacitor according to claim 11, wherein
the oxidation-reduction substance adsorbed onto at least one of the positive electrode side porous body and the negative electrode side porous body comprises an oxidation-reduction substance selected from a quinone coenzyme and a vitamin coenzyme causing the oxidation-reduction reaction during charging and discharging.

20. An electric double layer capacitor electrode comprising:
a positive electrode having a positive electrode active material layer including a positive electrode side porous body; and
a negative electrode having a negative electrode active material layer including a negative electrode side porous body, wherein
at least one of a quinone coenzyme and a vitamin coenzyme causing an oxidation-reduction reaction during charging and discharging is adsorbed onto at least one of the positive electrode side porous body of the positive electrode active material layer and the negative electrode side porous body of the negative electrode active material layer.
